(19) United States
(12) Patent Application Publication
(10) Pub. No.: US 2004/0204868 A1
(43) Pub. Date: Oct. 14, 2004

(54) Reduction of errors in non-invasive tissue sampling

(76) Inventors: John D. Maynard, Albuquerque, NM (US); Mark Ries Robinson, Albuquerque, NM (US); Trent D. Ridder, Sandia Park, NM (US); Shonn P. Hendee, Albuquerque, NM (US); Christopher D. Brown, Albuquerque, NM (US); Stephen J. Vanslyke, Albuquerque, NM (US); Cliona M. Fleming, Albuquerque, NM (US); Edward L. Hull, Albuquerque, NM (US)

Correspondence Address: INLIGHT SOLUTIONS, INC., 800 BRADBURY, SE, ALBUQUERQUE, NM, 87106, US

(21) Appl. No.: 10/410,006

(22) Filed: Apr. 9, 2003

(51) Int. Cl. G06F 19/00

(52) U.S. Cl. 702/30

(57) ABSTRACT

The present invention provides methods and devices for using feedback to improve non-invasive tissue measurements by making measurements faster, easier to perform, and less error prone. In some embodiments, a set of metrics is identified as measurable potential sources of measurement error that can be controlled by a user. In some embodiments, the set of metrics can be analyzed to determine which metrics are related to one another, and some possible error metrics can be discarded, and others used as surrogate metrics for measuring and monitoring measurement errors.

### REFERENCES TO RELATED APPLICATIONS

1. Field of the Invention

The present invention generally relates to a system for determining attributes of tissue, such as analyte concentrations therein, utilizing non-invasive optical techniques and multivariate analysis. More specifically, the present invention relates to a quantitative or qualitative spectroscopy system, incorporating real-time sampling metrics and feedback to a user to improve or maintain good interface formation or other desirable relationship between the tissue and the optical measurement system. This system can reduce measurement time and errors associated with sampling tissue during a non-invasive measurement of a property of tissue.

2. Background of the Invention

The non-invasive determination of tissue attributes by quantitative or qualitative spectroscopy has been found to be highly desirable, yet very difficult to accomplish. Non-invasive determinations via quantitative or qualitative spectroscopy are desirable because they are painless, do not require a fluid draw from the body, carry little risk of contamination or infection, do not generate any hazardous waste, can have short measurement times, and generate results without lab work delay. An example of a desirable application of such technology is the non-invasive measurement of blood glucose levels in humans. Other examples of non-invasive measurement include the quantification of arterial blood gases, blood urea (nitrogen) concentration, blood alcohol concentration, diabetes screening and diagnosis, cancer screening, and biometric verification and/or identification. In each of these measurements, spectroscopic properties of tissue are measured to quantify an analyte or classify a condition. The optical measurement of tissue is a complicated task and improper sampling of the tissue gives rise to errors that can degrade the accuracy and precision of the measurements.

FIGS. 1-3 include basic information and some examples of how non-invasive optical systems gather information regarding tissue analytes. FIG. 1 is a cross-section view of tissue 10 having a first side 12a and an opposing side 12b. Tissue 10 includes a dermis 14a, 14b, epidermis 16a, 16b and interior 18. Incident light 20 impinges first on epidermis 16a and dermis 14a. Some portion of incident light 20 undergoes epidermal and dermal reflections 22 due to refractive index changes occurring at the surface of the epidermis 16a and between epidermis 16a and dermis 14a. The incident light 20 can also be bent at those interfaces as shown 24.

The light enters interior 18 and undergoes reflections and refractions within tissue 10 due to the diverse anatomical features within tissue 10, including cellular structures, blood vessels, nerves, fatty deposits, bones, etc. Some of these features cause scattering 26. The spectral characteristics of the materials making up tissue 10 cause absorption 28 as well. Eventually, light is refracted and reflected, creating backscattered emission 30. Another portion of light will be transmitted 32 after passing through interior 18 and the opposing dermis 14b and epidermis 16b. Current spectroscopic systems generally measure the backscattered emission 30, the transmitted portion 32, or a combination thereof.

FIG. 2 is a schematic diagram of one configuration for performing a non-invasive measurement. Energy source 40 supplies optical energy to sensor 42 having sensor input 44, which couples the optical energy into tissue 10 through surface 11. The illustrative configuration of FIG. 2 is adapted to receive backscattered emission with sensor output 46, which couples the backscattered emission to spectrum analyzer 48.

FIG. 3 is a schematic diagram of one configuration for performing a non-invasive measurement. Energy source 40 supplies first sensor element 50 with optical radiation. First sensor element 50 couples the optical energy into tissue 10 via first surface 13a. A second sensor element 52 captures transmitted optical energy emanating from tissue 10 via second surface 13b, and couples the energy to spectrum analyzer 48. The illustrative configuration in FIG. 3 measures transmitted light. For the purposes of illustration, an interface-enhancing medium 54 is included to show one optional aspect of such a system.

Spectroscopic measurements can be used to determine the chemical content of a medium from the optical attenuation (absorbance) profile at several optical wavelengths. The Lambert-Beer law defines the relationship in a noise-free, single-component system of uniform pathlength:

I=I₀exp(−ε_{λ}cb) Equation 1

where I₀ is the intensity of light incident on the sample, I is the intensity of light measured at the detector, ε_{λ} is the wavelength dependent absorbance coefficient of the chemical component, C is the concentration of the component, and b is the pathlength through the system. In more complex systems, the signal measured at the detector can include noise arising from instrumentation electronics and noise arising from sample variation. Collection of numerous individual spectra, defined herein as scans, can reduce uncorrelated noise (real world systems generally exhibit at least some random or uncorrelated noise). The scans can be combined to produce a combined spectrum, improving the signal-to-noise ratio by reducing the uncorrelated noise terms. As an example, if the scans are combined by averaging, the uncorrelated portion of noise in the combined spectrum is reduced at a rate that is inversely proportional to the square root of the number of scans that are averaged. Thus, assuming that the time required to collect several scans is linearly related to the time required to collect a single scan, the increase in signal-to-noise ratio is proportional to the square root of the time spent collecting data.

Existing non-invasive measurement systems use quantitative or qualitative spectroscopy to measure certain analytes or properties in human tissue. These systems collect individual tissue spectra over some number of seconds or minutes before a non-invasive measurement is completed. The individual tissue spectra are often either coadded or coaveraged together to yield a single sample spectrum. A sample spectrum is defined as the result of the processing of the scan-to-scan spectra collected during the measurement period. Multivariate analysis can be performed on the sample spectrum or on the scan spectra to determine an attribute of the tissue.

Noninvasive measurement of many physiologically important tissue analytes can require a large number of individual scans. The signal contributed by the analyte of interest is typically several orders of magnitude smaller than the background signal contributed by other tissue absorbers and scatterers. Collection of spectral data from tissue can require that a significant number of spectra be coaveraged to obtain the necessary signal-to-noise ratio for making an accurate determination of the analyte of interest.

Conventionally, batch processing of data samples is used to eliminate scans that are unsuitable for use. In some approaches the individual scan spectra from a batch are compared to the mean or median scan from the batch. Outlying scans are characterized as having large deviations from the mean or median scan. Outlier measurements are then discarded, the scan set is reduced, and the analytical process restarted. Once the sample set is reduced to an acceptable group of measurements falling within a predetermined range of the mean, multivariate analysis can be performed to determine the constituent properties of the tested tissue sample. A shortcoming of batch processing methods is that a certain number of scans, or percentage of the sample, should remain in order to characterize the measurement and analysis as satisfactory. If too many of the measured scans are determined to be outliers, then the signal-to-noise ratio for the sample is unacceptable, the entire sample set must be discarded, and a new sample set collected.

FIG. 4 is a flow diagram of an example of a batch processing method. The process starts with the capture of several scans 60 of tissue (from a single area, or possibly from a plurality of areas). The individual scans are used to create a spectrum 62. The spectrum 62 is then compared to spectra from calibration samples 64. If the spectra are not compatible 64, the spectrum is identified as an outlier spectrum 66. An outlier spectrum is discarded 68, with production of an error signal, and the process restarts with capture of several scans 60. If the spectra are compatible, the spectrum is identified as a good spectrum 70. A good spectrum 70 is kept 72 for use in a determination step.

Restarting data collection is not always sufficient to obtain suitable scans. Some measurement conditions can vary widely in ways that can strongly impact the ability of a measurement system to capture an acceptable tissue sample set. Examples of such conditions include the presence of hair, lotions or residues on the tissue surface, the local tissue temperature, the location on the tissue being measured (for example, calloused skin on the hand of a subject can produce different spectra than smoother skin elsewhere), the stability of the apparatus/tissue surface interface, and variations in the distance between the measurement apparatus and the tissue sample surface. In these circumstances, suitable scans might not be obtained until the underlying cause is identified and corrected.

The effect of unsuitable scans on a user can be significant. Measurement times can increase as the system attempts to capture suitable scans, making use of the system more time-consuming. Also, the user's frustration (and consequent future non-use) can increase as the system continues to acquire additional scans, with no information available to the user other than a “not ready” light. Measurement attempts can fail altogether if the unsuitable scans are due to problems with measurement conditions and the problems are not corrected.

Accordingly, there is a need for noninvasive measurement systems that can efficiently detect and accommodate unsuitable scans, and that can facilitate correction of problem measurement conditions.

### SUMMARY OF THE INVENTION

The present invention provides methods and devices for using feedback to improve non-invasive tissue measurements by making measurements faster, easier to perform, and less error prone. In some embodiments, a set of metrics is identified as indicators of potential measurement error that can be controlled by a user. In some embodiments, the set of metrics can be analyzed to determine which metrics are related to one another, and some possible error metrics can be discarded, and others used as surrogate metrics for measuring and monitoring measurement errors.

In some embodiments, several error metrics are identified as relating to certain user behaviors or interface problems that can result in outlier measurement samples. Some embodiments use a method wherein individual sample spectra received by a non-invasive analyte measurement system are analyzed to determine whether and which errors can be identified in the scan or sample spectra. Some embodiments then relay information, or feedback, to the user, identifying which errors can be causing outlier spectra to be captured. In some embodiments, the feedback also includes directions to the user suggesting how the user can improve the sample spectra and reduce the number of outlier data samples captured.

Some embodiments use metrics derived from captured spectra taken during a given measurement. Some embodiments use metrics derived from spectra taken during calibration measurements. In some embodiments, metrics obtained in calibration measurements are derived based on an individualized calibration made for a single user. In some embodiments, metrics obtained in calibration measurements can be derived using data from a group of individuals sharing similar physiological characteristics. In some embodiments, additional metrics can be obtained using non-spectral measurements; for example, pressure sensors and temperature sensors can be used to define certain metrics.

Some embodiments give real-time feedback to the user to increase the likelihood of making and maintaining a good tissue interface with the instrument to reduce the time needed to complete an acceptable measurement. In addition, the invention in some embodiments provides useful information as to the nature of detected sampling abnormalities, for example, a bad interface between the tissue and the instrument, the presence of foreign substances (such as oil or lotion) on the tissue that interfere with the measurement, the presence of too much body hair at the sampling site, or tissue temperatures that are outside normal limits for the measurement.

### BRIEF DESCRIPTION OF THE DRAWINGS

FIG. 1 is a cross-section view of tissue.

FIG. 2 is a schematic diagram of one configuration for performing a non-invasive measurement.

FIG. 3 is a schematic diagram of one configuration for performing a non-invasive measurement.

FIG. 4 is a flow diagram of an example of a batch processing method.

FIG. 5 is a schematic representation of a system suitable for use with the present invention.

FIG. 6a is a simplified cross-section of a tissue-sensor interface.

FIG. 6b is a perspective view of the cross section shown in FIG. 6a.

FIG. 7a is a cross sectional view of an interface including an index-matching medium.

FIG. 7b is an example of a graph of absorbance with respect to wavelength.

FIG. 8 is a block diagram of analysis for an example embodiment of the present invention.

FIG. 9 is a block diagram of the operation of an example embodiment of the present invention.

FIG. 10 is a block diagram of an illustrative embodiment of the present invention having a non-invasive measurement system and a user interface.

FIG. 11 is an illustration of an example user interface.

FIG. 12 is an example of a chart showing the RMSED for several values and trends for several tailor metric candidates.

FIG. 13 is a chart of the correlations for several metrics with respect to the model out of band energy values metric.

FIG. 14 is a chart of the metrics against Mahalanobis distance and Q-statistic.

FIG. 15 is a chart of the metrics against Mahalanobis distance and Q-statistic.

FIG. 16 is a block diagram of calculation and measurement flow for an illustrative embodiment of the present invention.

FIG. 17 is a block diagram of an example embodiment of the present invention.

FIG. 18 is an illustration of an example embodiment of the present invention.

FIG. 19 is a graph comparing several grouped metrics to the Mahalanobis distance for the same subject.

FIG. 20 is a graph of RMSED as a function of included determinations.

FIG. 21 is a high level flow chart for obtaining a glucose measurement.

FIG. 22 shows comparison of several metrics.

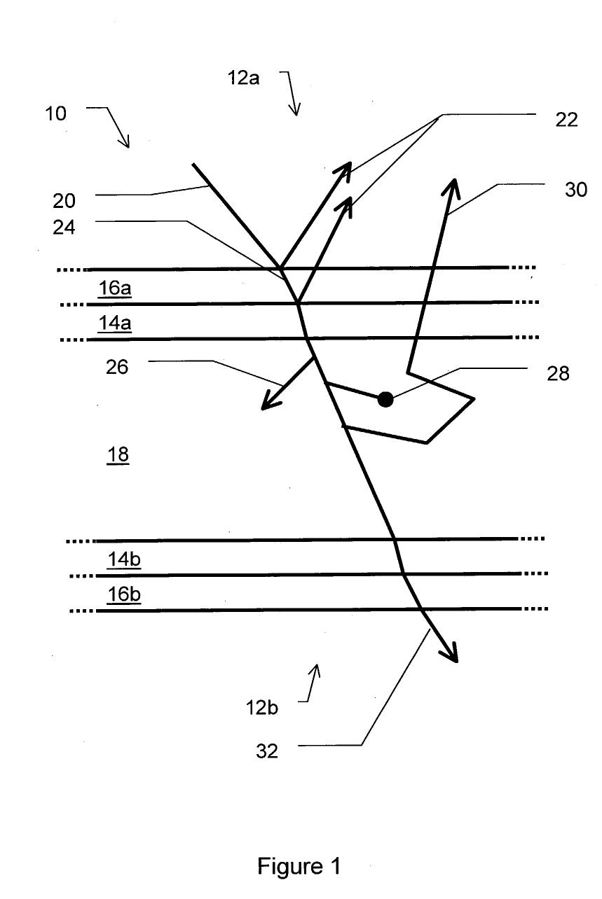

### DETAILED DESCRIPTION OF THE INVENTION

Some embodiments of the present invention include a spectrometer, a data processing module and a user interface module. The spectrometer can be any of several such devices for irradiating a sample and capturing light which returns back from the sample or that propagates through the sample. For some embodiments of the present invention, the spectrometer can function in the near-infrared (approximately 0.7-3 μm) portion of the optical spectrum, particularly for measurements involving blood glucose monitoring in human tissue. However, for other embodiments, the spectrometer can operate in other ranges of wavelengths and, indeed, embodiments of the present invention are equally useful and effective regardless of the range of wavelengths the spectrometer is adapted for monitoring. In one embodiment, the spectrometer can include a broadband light source, focusing and transfer optics, a fiber-optic sampler having source and detection fiber bundles, an interferometer and a detector unit.

The description herein refers to various terms. Several of those terms should be read with the following definitions in mind, unless the context clearly indicates otherwise. A “scan”, when used in the context of data, generally refers to a single data set collected from an instrument, generally a set of wavelength/response characteristics collected from a single illuminate/detect cycle. An “insertion group” refers to a group of scans, generally a group of scans obtained from a single insertion, where an “insertion” refers to the establishment of an interface between an instrument and a sample. A “sample group” refers to a collection of insertion groups, for example, a collection of insertion groups collected from a single sample during a single measurement session. A “spectrum” or “spectra”, when used in the context of data, generally refers to any illumination/response relationship, including a single scan, a plurality of scans, insertion groups, and sample groups. A “subject” refers to that which is being illuminated and whose properties are of interest; for example, tissue whose spectroscopic response is analyzed according to the present invention.

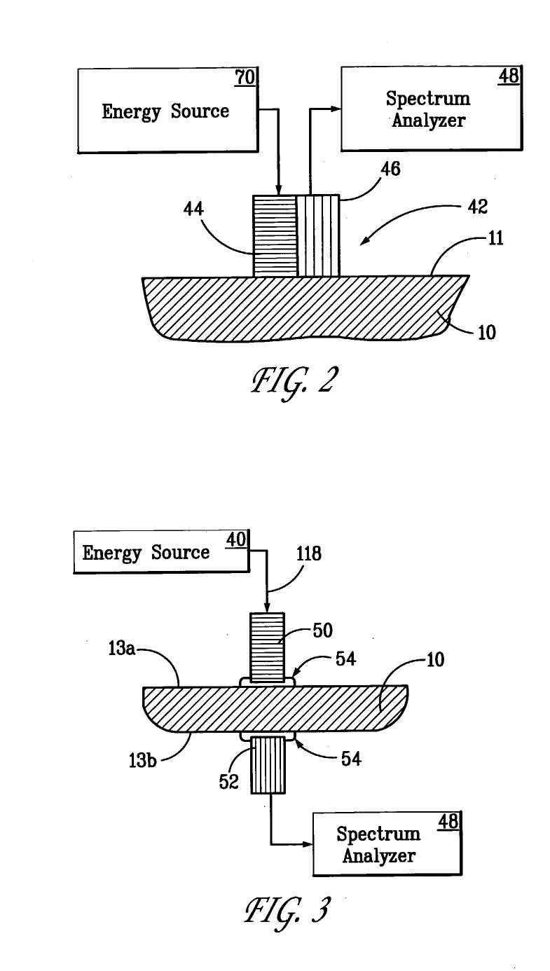

Although various elements, devices and configurations are shown throughout these figures, for example, FIGS. 2-4, the present invention can be applied to systems using different overall structures to produce similar results. The various elements, devices and configurations are included for illustrative purposes. One of skill in the art can readily appreciate that there are a variety of ways to apply the present invention to systems differing in various ways from those shown herein.

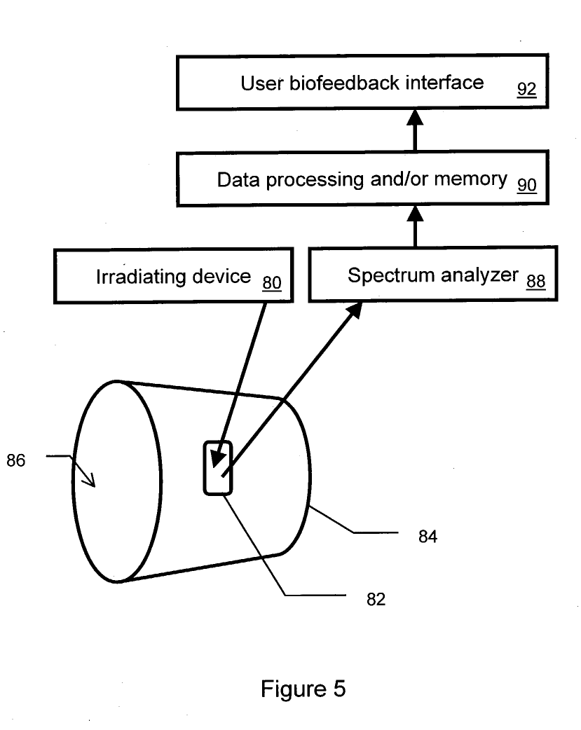

FIG. 5 is a schematic representation of a system suitable for use with the present invention. Irradiating device 80 supplies radiation to sensor element 82. Sensor element 82 can be integrated into sleeve 84 as shown, sleeve 84 including an opening 86 on at least one end. Sleeve 84 can be sized for insertion of the forearm or finger of a subject. Other configurations are also possible, for example, a clip for holding a sensor against a subject's earlobe, or a collar for placing around a subject's neck during measurement, or a surface for positioning adjacent a subject's tissue, or a variety of non-contact configurations. See, e.g., “System for Non-invasive Measurement of Glucose in Humans”, U.S. patent application Ser. No. 09/832,585, incorporated herein by reference. Sensor element 82 also provides an output to spectrum analyzer 88. Spectrum analyzer 88 converts the optical information coming from sensor element 82 into data for data processing unit 90. Data processing unit 90 can control and provide data to user interface module 92 that can then be used to provide feedback to a subject.

User interface module 92 can include a display for reporting various measurement parameters. Such parameters can include, as examples, a status indicator that reports progress toward completion of data acquisition for the current measurement, a display section indicating status of the tissue/instrument interface, a display section for providing instructions in the event that corrective action is indicated to improve the quality of scans during the current acquisition, and a display section for reporting the result of the measurement. The user interface module can also include a speaker or other device for providing an audible signal or audible instructions for alerting the subject regarding measurement and/or interface status.

Data processing unit 90 can include an analog to digital converter for digitizing an analog detector signal and converting the spectrometer output to its spectral representation. Data processing unit 90 can also provide processing electronics and data storage capacity for applying algorithms used to determine spectral quality (e.g., detecting outliers, or detecting acceptable spectra) and for accumulating (e.g., by coaveraging) valid spectra into a combined spectrum. Data processing unit 90 can further provide processing capabilities for applying analyte quantification algorithms to the resulting spectrum to determine and report the analyte concentration.

Various methods can be used to assess spectral quality. Some methods use the magnitude of a spectroscopic peak, which is estimated from a single wavelength or combining a continuous region of the spectrum. In near infrared spectroscopy of soft tissues, such as the skin, water has dominant absorbance peaks at approximately 5190 and 6910 cm⁻¹. The magnitude of these peaks and the relationship between them is influenced by the quality of the interfacial contact between instrument and tissue. Thus metrics based on the magnitudes of spectral peaks can be used for monitoring the consistency of subsequent scans to distinguish between valid and invalid scans.

In one method of identifying outlier spectra, the data processing unit contains a representation of characteristics of the general shape of tissue spectra. The distance, as defined by a distance metric, of a spectrum from the general shape can be used to identify outlier spectra. For example if the representation comprises principal components, new spectra can be projected onto each principal component by taking the vector dot product between them. The resulting scores (dot product magnitudes) can then be evaluated against the scores of the spectra used to determine the principal components to identify outlier spectra. An example of this type of metric is Mahalinobis distance. Other metrics that are calculated from a principal component representation are lack-of-fit statistics, such as the Q-statistic, which indicate if the test spectra has features not consistent with the spectra used to determine the principal components. See, e.g., Weisberg, Applied Linear Regression, second edition; Westerhuis et al., Generalized contrbution plots in multivariate statistical process monitoring, Chemometrics and Intelligent Laboratory Systems 51 (2000) 95-114.)

Some embodiments of the present invention involve a process wherein captured spectra can be analyzed to select a set of metrics. Initially, a large number of metrics can be identified; in the process of developing one embodiment of the present invention nearly one hundred metrics were identified and defined, and many more are possible. The number of metrics to examine can be reduced, for example, by applying identified metrics to spectra gathered under a variety of conditions, then determining the correlation between metrics, then grouping those metrics with high correlations. High correlation between two metrics means that the information in one can be at least partially inferred from the information in the other. Consequently, for groups of highly correlated metrics, one (or more) can be chosen as representative of the group, and the others disregarded or combined with the representative metric. A correlation can be considered high depending on considerations specific to the metrics involved. Metrics can also be evaluated based on their sensitivity to measurement conditions.

Additional embodiments identify subject-affected characteristics of the measurement spectra, and correlate those aspects with the metrics. For example, several preliminary metrics can be identified as related to the strength of water absorption occurring in the tested tissue. Variance of these metrics during measurement can be attributed to a variety of possible problems: as examples, the user might not be holding the sensor to the tissue steadily; the user might have placed the wrong area of tissue adjacent to the sensor; the tissue surface might be overly wetted; and characteristics of the radiation source might be varying. Analysis of other metrics can eliminate some of these possibilities, but a preliminary step to eliminating possibilities includes identifying which metrics are most likely to indicate problems are occurring. Troubleshooting of the user's testing techniques can be assisted by creating an association of outlier metrics to user-controllable problems. Then, after this process of selecting metrics to monitor and creating an association between metrics and their causes, a user interface can be used to indicate whether a measurement problem is occurring and to indicate to the user how the problem is likely to be reduced. The combination of elimination of metrics through correlation and grouping along with creation of an association allows the user interface to provide real-time feedback to the user.

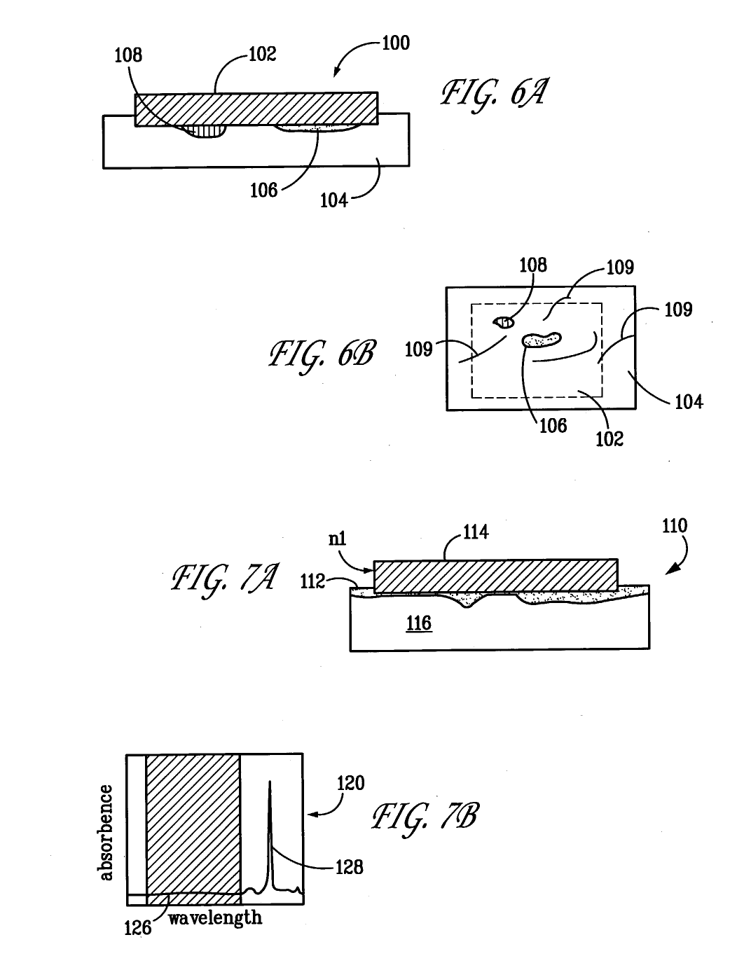

FIG. 6a is a simplified cross-section of a tissue-sensor interface 100. Sensor 102 is applied to tissue 104. An air gap 106 and dirt 108 can corrupt the interface. Air gap 106 can foster excessive specular reflection along the interface, because light entering tissue 104 passes from sensor 102 through air gap 106 to tissue 104, creating reflections and refractions not indicative of the tissue response intended to be measured. Passage through multiple dielectrics can also create a wavelength selective reflection, complicating the measurement even more. Dirt can alter the response characteristics by changing the scattering and absorption properties.

FIG. 6b is a perspective view of the cross section shown in FIG. 6a. Sensor 102 is applied to tissue 104, and air gap 106 and dirt 108 are noticeable. Hairs 109 can further corrupt the interface. For some non-invasive systems, the tissue area at which testing is to take place is shaved to prevent hairs 109 from interfering in the interface 100.

The present invention can help detect and diagnose interface troubles like those shown in FIGS. 6a and 6b, including air gap 106, dirt 108, and hairs 109, before a complete set of scans is obtained. This can be significant when a large number of scans are desired, e.g., for increased accuracy as discussed before.

FIG. 7a is a cross sectional view of an interface 110 including an index-matching medium 112 between sensor 114 and tissue 116. As noted in the figure, and indicated by the name, the index matching medium 112 and the sensor 114 are designed of materials having an index of refraction approximately equal to that of the tissue 116. The reflection at an interface is related to the indices of refraction as in equation 2.

$$R = {( \frac{{n}_{1} - {n}_{2}}{{n}_{1} + {n}_{2}} )}^{2} \qquad Equation 2$$

Thus, when n₂≈n₁ the reflectance will be very small. Referring to FIG. 3, interface enhancing media 54 can be index matching media 112, for example. FIG. 7b shows an additional possible advantage of the present invention used in connection with index matching media 112. FIG. 7b shows an example of a graph 120 of absorbance 122 with respect to wavelength 124. In the illustrative example for FIG. 7b, there is a range of wavelengths of interest 126 among those in the spectrum. The index matching medium 112 in FIG. 7a can include a substance having a sharp absorbance peak 128 outside the range of wavelengths of interest 126. Thus, an additional application of the present invention is shown: it can detect a particular band of wavelengths to determine whether a subject has properly applied, for example, an index matching medium 112. This concept can also be used to detect other substances that the subject might be asked to apply, for example, a cleanser used to prepare tissue 104 that includes a substance intended to leave a residue if it has been properly applied, or a cleanser that leaves a detectable residue if not properly removed.

In some embodiments of the present invention certain metrics are defined with criteria (e.g., a range of acceptable values, or a threshold), which each spectrum must satisfy. For a scan-level metric, processing and troubleshooting of received scans can begin as soon as the first scan is received. Consequently, flawed data can be identified and rejected as it is received. Also, the user can be informed prior to completion of a measurement that a problem is or has been occurring. The user is thus afforded the opportunity to correct a measurement problem while a measurement is being taken. After (or during, if applicable) correction, data capture can restart (discarding the current problem scan and previous scans in this set) or resume (discarding the problem scans but keeping any acceptable scans from this set).

The present invention also contemplates metrics that are likely indicators of measurement problems. For example, a set of a metrics that can be quickly determined and analyzed is defined. These metrics are used to provide quick feedback to the user about system performance; they do not need to be conclusive as to whether a given spectrum is an outlier. These metrics and the associated feedback can assist the user in improving data capture conditions during data capture, without requiring complete spectral analysis.

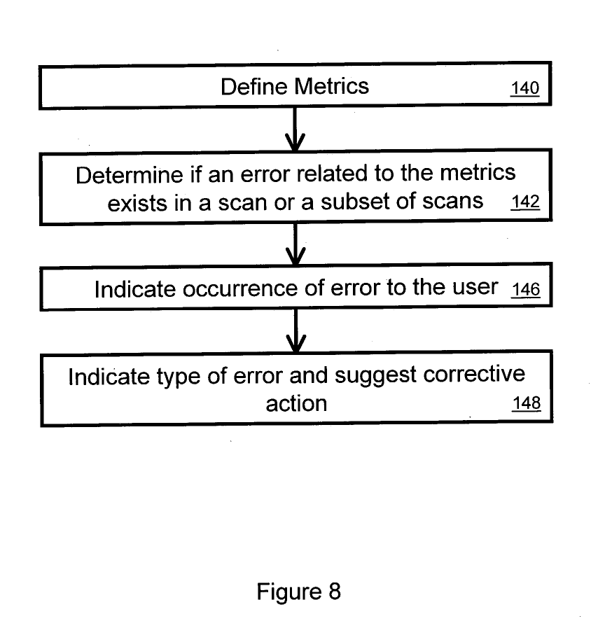

FIG. 8 is a block diagram of analysis for an illustrative embodiment of the present invention. Metrics likely to detect measurement errors are defined 140. Each tissue scan is analyzed to determine if an error exists 142. If an error is detected, the illustrative embodiment indicates the occurrence of an error to the user 146, and indicates the type of error and suggests a corrective action 148. Detection at the scan level allows notification and corrective action during measurement, rather than after, and can enable an initially flawed measurement to be carried out without restarting by taking corrective action before all scans are completed. Suggestion of a corrective action allows the user to participate in improving the quality of the measurement, and can help the user learn to prevent errors in the future.

Scans obtained before a corrective action can be kept if the intervening measurement errors do not disqualify all scans. For example, an unsteady interface caused by shaking of the measurement device can result in a good scan being followed by a bad scan. Identification of the unsteady interface can indicate that the bad scan should be rejected due to, for example, insufficient received power. Scans with sufficient received power, however, can be kept. The system can, for example, require a certain percentage (e.g., ninety percent) of scans to be kept in order for scans taken during the measurement period to be the basis for a measurement. Such a requirement can be met for example, if the measurement period is one hundred seconds and the shaky interface corrupts half of the scans taken during the first sixteen seconds. About ninety two percent of the scans remain unaffected by the shaky interface, corrected after sixteen seconds. Assuming no other sources of error corrupt any other scan, the measurement can be used even though there was an error in one of the initial scans. As other examples, bad scans can stem from a subject with a physical disability or impairment (e.g., intoxication) that makes consistent sampling difficult; discarding bad scans from the middle of acquisition can allow an attribution determination when no continuous sequence of scans would be sufficient.

A metric can comprise a determination of a biological attribute, and can be used to inform subsequent spectrum acquisition. For example, a spectrum that produces an attribute determination that is inconsistent with determinations from other spectra in the measurement can be discarded. As another example, the time allowed for spectrum acquisition, the number of acceptable scans required, the treatment of other metrics (e.g., the quality of scans acquired), and parameters of spectrum acquisition (e.g., instrument parameters) can all depend on metrics comprising a determination of a biological attribute. For example, a preliminary determination of low glucose level, from analysis of a first spectrum, can indicate that additional spectra are required to yield the desired accuracy and precision.

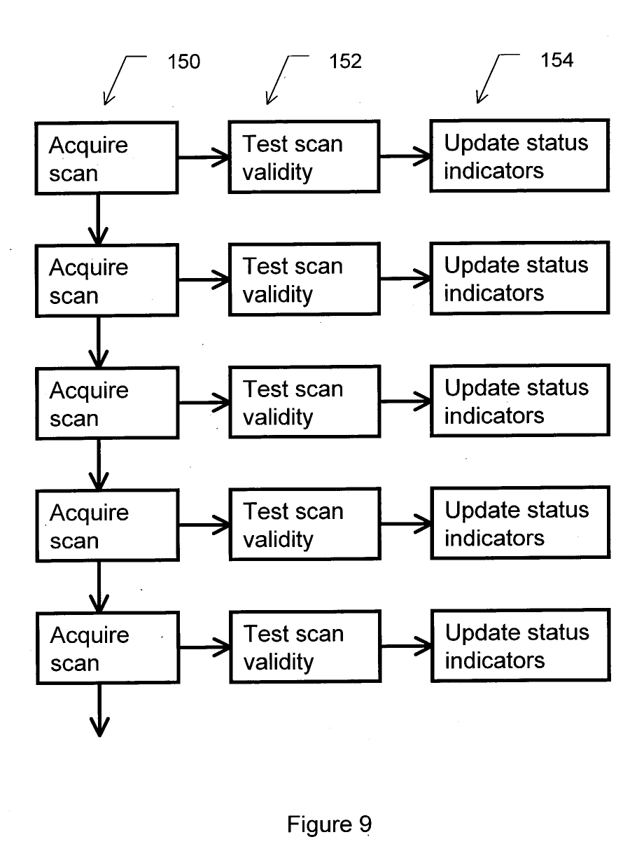

FIG. 9 is a block diagram of the operation of another example embodiment. A sequence of new scans of a tissue sample is obtained 150. The example embodiment tests scan validity 152 after each scan. After each scan, the example embodiment updates a collection of status indicators 154. The status indicators can, for example, indicate the distance of a scan from an error threshold. The example embodiment, by testing 152 and updating 154 after each scan 150, can provide a real-time feedback loop.

Table 1 and Table 2 show data analysis in some illustrative embodiments of the present invention. The illustrative examples shown in these figures are purely for illustrative purposes; the numbers used have been inserted simply to show how an illustrative data analysis might progress. The numbers do not necessarily represent actual data, particularly the tested result and threshold numbers given.

Table 1 depicts an analysis table relating to an embodiment using analysis of scan-level spectra. The metric column lists brief descriptions of the physical nature of several metrics; these metrics can be derived from initial metrics that come directly from scans and involve an intermediate comparison to some other data. For example, data noting where in the spectrum features corresponding to urea would be noted. The tested result column lists the results of comparisons between the metric values from the current set of scans and the metric values from a representative group of acceptable scans. A threshold column lists the threshold for error detection for each of the metrics. Analysis of the thresholds with respect to the tested results reveals whether the metrics are within thresholds, leading to conclusions. The conclusions lead to several diagnoses of what problems or positive results have been attained. An additional aspect of analysis is to use the diagnoses to form potential suggestions for the user's course of action. Analysis of the suggestions can lead to a conclusion that can be given to the user in a direct, readable and understandable form.

The illustrative analysis in Table 1 contains three metrics. Conclusion column indicates that both “Change in Peak Water Absorption” and “Urea Concentration” metrics have values that are outside their respective thresholds. The diagnoses note that there is too little reflected power and that sweaty or dirty skin can be obstructing accuracy. The metric for change in peak water absorption does not necessarily provide a direct answer to why there is too little reflected power being captured (the example uses the configuration in use in the illustrative example is that of FIG. 2 above, where backscattered light is monitored). However combining that with the “Urea Concentration” metric suggests that the user's skin is sweaty. Extra sweat can include water at the surface of the tissue, through which any light would have to pass twice. Forcing light to pass through sweat twice can cause excessive absorption at water and urea peaks as well as increased diffusion of incident and exiting light due to the additional index of refraction change at the interface, thereby reducing received power.

TABLE 1

| | | | | | Possible |
|---|---|---|---|---|---|
| Metric | Tested Result | Threshold | Conclusion | Diagnosis | Suggestions |
| Difference | 0.6% root | RMSC from | Correct base | Correct tissue | None |
| from user's | mean squared | user's base | spectrum | area sampled | |
| base spectrum | change | spectrum <1% | | | |
| Change in | −0.2 | −0.1 AU | Insufficient | poor contact | Check device |
| peak water | Absorbance | | water signal | between tissue | operation; |
| absorption | Units (AU) | | | and sampler | large air gap; |
| from a base | | | | | misalignment |
| spectrum | | | | | of light input; |
| (current-base) | | | | | dirty surface |
| Urea | >Y | Y | Too much urea | Sweaty or dirty | Wash skin to |
| concentration | | | present | skin | remove sweat |
| | | | | obstructing | and start again |
| | | | | accuracy | |

Conclusion: tissue area dirty; suggest user wash, rinse, dry, and reinsert.

Table 2 is another example analytical table. Metric column contains three metrics. Two metrics provide thresholds for changes from scan to scan, while the third provides a threshold that compares data captured exiting the tissue area to the optical power input to the tissue area in a single scan. These metrics are monitored to yield tested results which are in turn compared to thresholds. The “Peak Water Absorption” metric in Table 2 assumes that the intensity of incident light on the tissue sample can be known. As examples, the intensity can be known based on calculations during calibration that check the strength of the light source, and can be known from measurements with each scan where some sensor element monitors light source power. Either approach can be added to the schemes shown in FIGS. 2 and 3, showing that the schemes in those figures are not intended to be comprehensive to all systems and are merely illustrative.

Diagnosis column can include,for example, a diagnosis that the tissue area is not equilibrated if the analyte concentration is determined to be changing rapidly. Equilibration can be significant if the tissue property that affects the optical characteristics of the tissue is not in equilibration with the attribute whose determination is desired. This is particularly true when, for example, the subject's blood glucose level is changing quickly, since glucose concentration in tissue can lag behind its concentration in blood. See, e.g., “Apparatus and Method for Non-invasive Spectroscopic Measurement of Analytes in Tissue Using a Matched Reference Analyte”, U.S. patent application Ser. No. 10/116,269, incorporated herein by reference.

However, the actual conclusion does not derive solely from the change in mean energy metric, because the peak water absorption change metric is also out of its acceptable range. The system can prioritize a conclusion based on changing water absorption over a conclusion based on changing mean energy metric. Such prioritization can be included throughout the data analysis where appropriate. Table 2 illustrates one situation where it is appropriate, since the “device not steady” conclusion explains both the changing water absorption and the changing mean energy.

TABLE 2

| | | | | | Possible |
|---|---|---|---|---|---|
| Metric | Tested Result | Threshold | Conclusion | Diagnosis | Suggestions |
| Change in | Changed by - | Change by less | mean energy | too little energy | interface |
| mean energy | 20% | than 10% | changing too | received | unstable |
| between scans | | | quickly | | |
| Peak water | 33 dB drop | Between 31 | In range | No error | None |
| absorption | from input | and 34 dB drop | | | |
| Peak water | Changed by | Change by less | Water | Not obtaining | Check if |
| absorption | 1.1% | than 0.2% | absorption | similar scans | devices is |
| change relative | | | changing too | | steady |
| to previous | | | quickly | | |
| scan | | | | | |

Conclusion: device is not steady; suggest user press tissue to device more firmly.

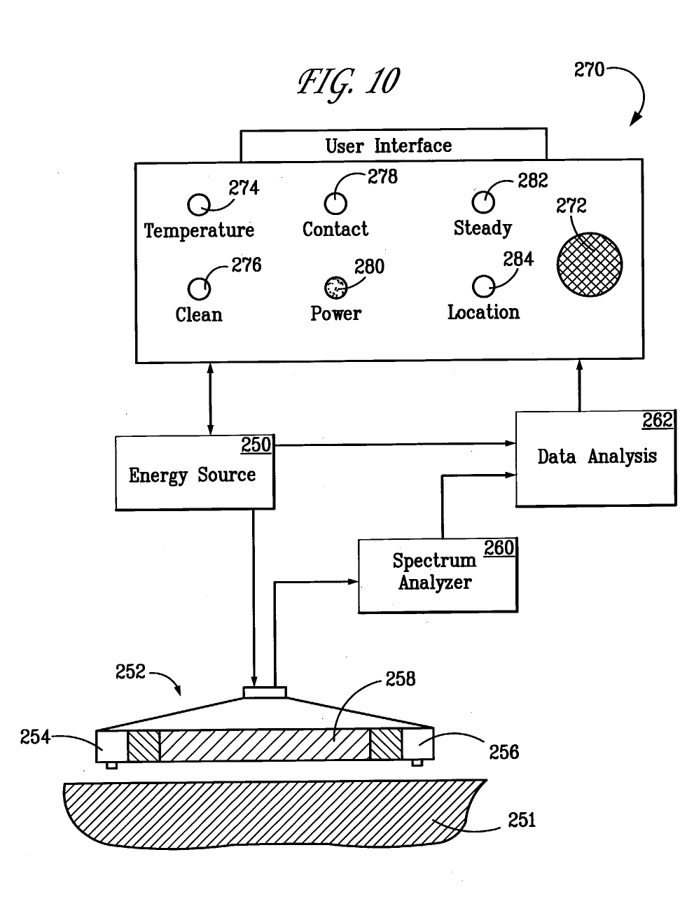

FIG. 10 is a block diagram of an illustrative embodiment of the present invention having a non-invasive measurement system and a user interface. Energy source 250 irradiates tissue 251 via sensor 252. Sensor 252 includes optical transmission element 258, pressure sensor 254, and temperature sensor 256, which contact tissue 251. Pressure sensor 254 can be included to assure proper contact to tissue 201. Temperature sensor 256 can be used to adjust analytical tools to accommodate a tissue sample which is at an unexpected temperature, to provide feedback to the user about a measurement problem resulting from improper tissue 251 temperatures, or to provide data to a tissue/vasculature equilibration apparatus that relies on localized heating of tissue to accelerate equilibration of the tissue 251. Other information that is not included in the scan can be used to augment the metric determinations, for example temperature and pressure sensors as in the figure, as well as contact sensor, ultrasound sensor, Doppler blood flow determination, visible images, dye recognitions, indication of user condition such as medication, and indications of measurement environment conditions. Such auxiliary sensors can be used in combination with metrics determined from spectra to improve the quality of spectra acquired and to improve the quality of feedback provided to a user.

Sensor 252 captures backscattered light from tissue 251 and couples it to spectrum analyzer 260. Spectrum analyzer 260 provides data to data analysis block 262. Data analysis block 262 can also receive data from energy source 250, for example, an indication of the intensity of light emitting from energy source 250, or indications relating to sampling or timing. Data analysis block 262 provides information to, or alternatively, controls, user interface 270. User interface 270 can also receive information from energy source 250.

User interface 270 illustrates one of several possible designs for feedback, comprising several features that can be used in combination with other features. For example, speaker 272 is included for providing an audible signal to indicate measurement status (e.g., occurrence of problems, completion of measurement). Also, lights 271 can change color or illumination depending on measurement conditions. Lights 271 can indicate temperature 274, sensor/tissue interface cleanliness 276, proper contact 278, power on/off 280, interface steadiness 282, and whether the sensor is located correctly on the tissue 284. Other status indicators can also be included, and those shown can be excluded, depending on the characteristics desired.

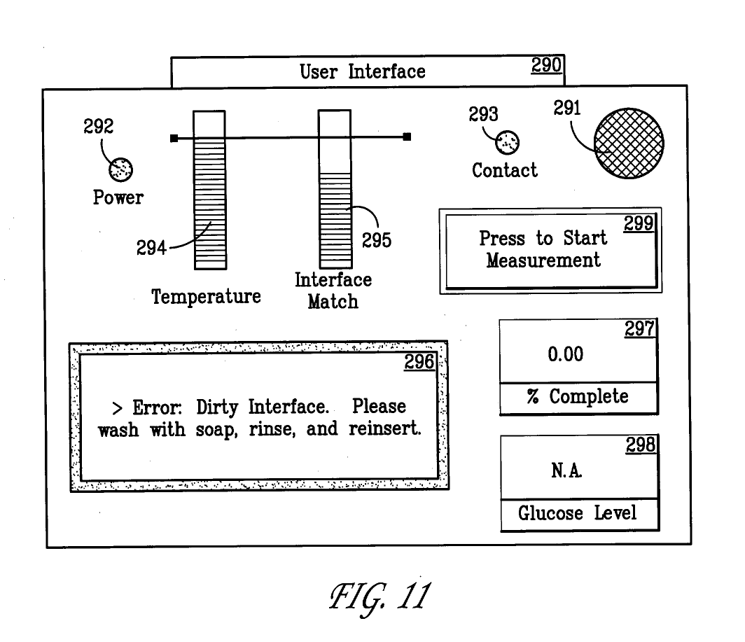

FIG. 11 is an illustration of another example user interface 290. Speaker 291 can provide an audible tone to indicate status, and can provide audio prompts to a subject, for example, audibly guiding the subject through specific actions related to the measurement. Power light 292 indicates whether the power is on, and contact light 293 indicates whether proper contact with tissue has been made. Meanwhile a graphical interface shows the degree to which temperature 294 and interface match 295 metrics are being met; the interface shown uses a rising bar-graph display to indicate level of compliance, distance from ideal, or a measurement error likelihood determined from combining the two metrics.

User interface 290 also includes three text-based indicators. Text screen 296 provides text feedback or suggestions to a subject. In the figure, text screen 296 indicates an error with a dirty interface, and suggests “Please wash with soap, rinse, and reinsert.” Progress text area 297 indicates how much progress has been made toward completion of a measurement, and results text area 298 will, when the measurement is complete, indicate the glucose concentration measured by the device. In the figure, result text area 298 does not indicate a result because the measurement is incomplete. User interface 290 also includes a start button 299. These features are included for illustration, and are not intended to be limiting.

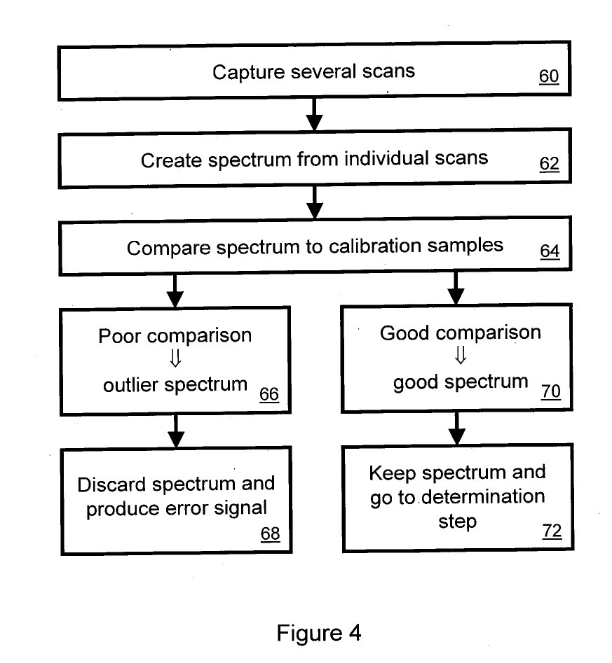

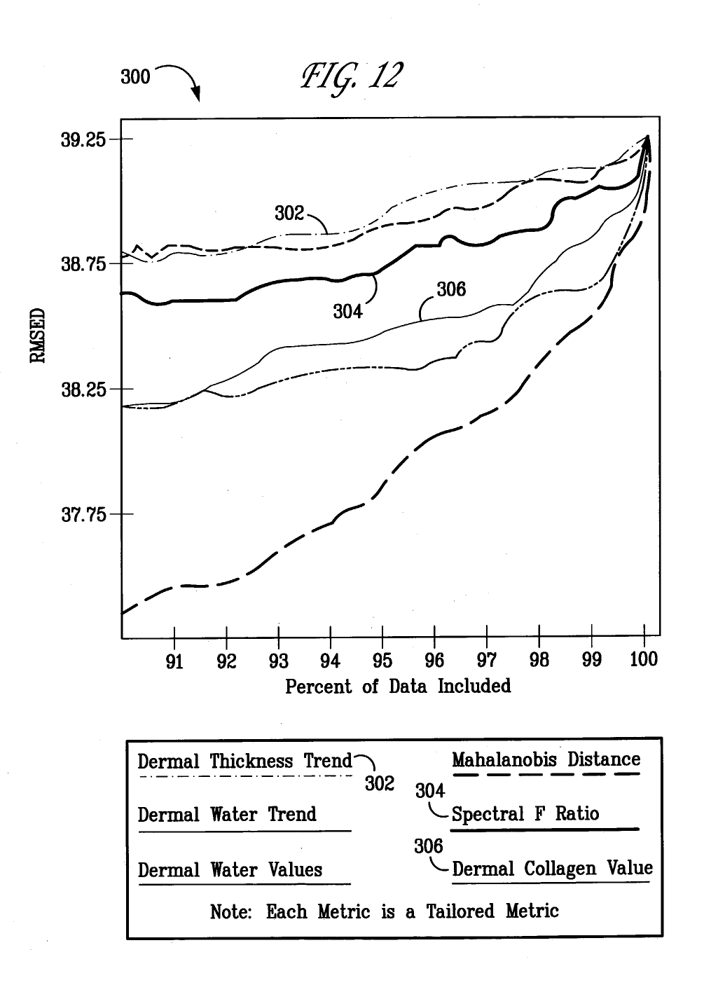

FIGS. 12-15 include aspects of an illustrative embodiment of methods used for selecting metrics for use as scan-level indicators of likely measurement level outliers. The illustrative embodiment begins by defining metrics as measurable items related to the likelihood that the subsequent analysis will produce useful results using that scan, e.g., whether the instrument/sample interface is appropriate, and whether the sample is consistent with the analysis assumptions. The term insertion is used descriptively because, in several embodiments and as shown above in FIG. 4, the sensor apparatus can include a collar or sleeve into which the arm of a user is inserted. For each insertion, a number of scans of the tissue are taken before the arm of the user is withdrawn. For the illustrative embodiment shown, an insertion period of 15 seconds was used. In some embodiments, an insertion is merely a period of data capture such that there is no physical “insertion” involved, and it is also possible to capture two or more “insertion” level blocks of data without the user terminating contact with the sensor being used.

For the illustrative example, the metrics can be divided into two categories: metrics designed to increase confidence that an insertion is within the calibration model space (used for all subjects or a group of subjects similar to the current subject), and metrics designed to increase confidence that an insertion is within the usual space of this subject's metric values (specific to each subject, the “tailor space”). See, e.g., “Methods and Apparatus for Tailoring Spectroscopic Calibration Models”, U.S. patent application Ser. No. 09/672,326, incorporated herein by reference.

The example embodiment uses the Mahalanobis distance and the Q-statistic as benchmarks for evaluating the effectiveness of other metrics. Development of primary metrics for use in this model starts with three considerations: metrics that incorporate model-independent information; metrics that are reliant on spectral features that are believed to be critical or important; and metrics that allow lower level information, including single scan information, to be investigated. Using an existing collection of spectral samples, the preliminary metrics shown in Table 3 were developed. For each metric in the table, three aspects were determined (where appropriate given the metric): values (the value of the metric for that spectrum), STD (the standard deviation of the metric values over a group of spectra), and trend (the structure, e.g., time-based trends, of the metric values over a group of spectra). Trend metrics and value metrics of each type were calculated both as calibration model metrics and as tailor metrics.(where a “tailor metric” is a metric whose determination is specific to a subject, whether applied to raw data or data that has been adjusted relative to the subject).

TABLE 3

| | |
|---|---|
| Mean energy | measure of the total energy/intensity of the spectral signal within the range of |
| | interest (typically 4000 to 8000 cm⁻¹ near-infrared spectroscopy) |
| Out-of-band energy | measure of the spectral energy/intensity in a region of the spectrum where |
| | no optical energy is expected (for example at wavenumbers beyond a optical |
| | filter's cut-off or beyond the detector's response region). Signals in these |
| | regions can indicate the instrument is not operating as expected. |
| Scan change | measure of the change in total energy observed from scan-to-scan while |
| | acquiring data. |
| Cepstrum | Measure of the power of a periodic interference. See Signal Processing |
| | Toolbox User's Guide (Mathworks Inc.) |
| Absorbance variance | measusre of the scan-to-scan change in the spectral signal after conversion |
| | to absorbance units. |
| Specular | measure of the magnitude of the specular energy seen at the detector |
| | (specular referring to energy which has reflected off the surface of the |
| | tissue/sample without propagating into the tissue/sample). This is typically |
| | measured in spectral regions where the sample would otherwise absorb |
| | most of the energy, such the peak absorbance of tissue around 5200 cm⁻¹. |
| Peak to trough | ratio of absorption by a spectral peak to to the absorption of a neighboring |
| | region with low absorbance (the trough). |
| PCA scan MD | Mahalinobis (in-plane) distance of a scan to the model |
| PCA scan Q-statistic | Spectral residual metric (out-of-plane distance to the model) for a scan |
| Dermal Thickness | thickness of the dermis (mm) at the sampling site |
| Dermal Water | concentration of water (mg/dl) at the sampling site |
| Dermal Collagen | concentration of collagen (mg/dl) at the sampling site |
| Mean Scatter | average value of the scattering coefficient (mm⁻¹) in the wavelength region of |
| | interest |
| Scatter change | Change in the scattering coefficient (mm⁻¹) in the wavelength region of |
| | interest |
| effective pathlength | measure of the effective propagation distance through the dermis (mm) of |
| parameters | photons that contribute to the detected signal at a specified wavelength; see |
| (path metrics 1-8) | text for details |

The skin properties identified in the final six rows of Table 3 can be calculated from the measured reflectance spectrum using a multivariate calibration model that is derived from synthetic (i.e., simulated) spectra. The first step in creating such a model is to establish a reliable method for generating a synthetic NIR reflectance spectrum of biological tissue. A variety of approaches is possible; we utilized Monte Carlo simulations of photons that were launched from our measurement probe, traversed human skin, and were subsequently re-collected by the probe. See, e.g., L. H. Wang, S. L. Jacques, and L. Q. Zheng, “MCML—Monte Carlo modeling of photon transport in multi-layered tissues,” Comp Meth Prog Biomed 47:131-146 (1995).

To enhance the usefulness of the synthetic spectra, one can generate many such spectra, spanning the range of wavelength-dependent tissue absorption and scattering properties expected in the population of individuals to be measured. In the embodiment described here, we varied the thickness and temperature of the dermis, the collagen and water content of the dermis, and the temperature, lipid content, and water content of the subcutaneous tissue. Together these parameters specify the dermal and subcutaneous absorption spectra, μ_{a derm}(λ) and μ_{a subcu}(λ). In addition, we varied the skin scattering spectrum, μₛ(λ). We established the mean values, variance, and covariance of these simulation properties from the scientific literature (see, e.g., R. H. Pearce and B. J. Grimmer, “Age and the chemical constitution of normal human dermis,” J Invest Derm, 58: 347-361 (1972), and T. L. Troy and S. N. Thennadil, “Optical properties of human skin in the near infrared wavelength range of 1000 to 2200 nm,” J Biomed Opt 6: 167-176 (2000)), from measurements made at our facility (including, for example, measurements of dermal thickness using high-frequency ultrasound), and by assessing the similarity of the synthetic data to measured skin reflectance spectra.

After a large set of synthetic data has been generated, a multivariate calibration technique such as partial least-squares (PLS) can be used to create a model that relates the measured spectrum to the skin property of interest. Once this model is created, appropriate steps can be taken to ensure that it is consistent with the experimental data to which it will be applied. Again, several approaches are suitable. We assessed compatibility by ensuring that the Q-statistic and Mahalanobis Distances of experimentally measured tissue reflectance spectra were not significantly elevated relative to those of the synthetic calibration spectra. Where possible, we also compared the parameter estimates returned from the synthetic models to experimentally measurable quantities. For example, we compared estimates of the dermal thickness generated by the synthetic models to high-frequency ultrasound measurements of the dermal thickness that were made at the same time the infrared spectra were acquired.

The ‘mean scatter’ parameter in Table 3 specifies the average value, in inverse millimeters, of the tissue scattering spectrum in the wavelength region of interest, μₛ(λ). The ‘scatter change’ parameter specifies the change in the tissue scattering spectrum, in inverse millimeters, in the wavelength region of interest: scatter change=μₛ(λₘᵢₙ)−μₛ(λₘₐₓ). The effective pathlength parameters are a measure of the average distance traversed through the dermis by photons that contribute to the signal at the detector. For any given wavelength, the effective pathlength (l_{eff}) is defined by:

$${l}_{eff} = \frac{{\sum }_{i = 1}^{N} {l}_{i} {ⅇ}^{{μ}_{a} {l}_{i}}}{{\sum }_{i = 1}^{N} {ⅇ}^{{μ}_{a} {l}_{i}}}$$

where N is the total number of photons collected, μₐ is the dermal absorption coefficient at wavelengths of interest, and Iᵢ is the dermal pathlength of an individual photon. A number of path metrics (1-8 in Table 3) can be determined from the pathlengths at given wavelengths, or from combinations of pathlengths at multiple wavelengths, where the wavelengths can be chosen based on the property of interest (e.g., for glucose in human tissue, pathlength metrics at 4000-4500 cm⁻¹ can be used).

Determinations of tissue analyte concentrations were then made for the set of insertions performed, and the determined values were compared to actual values (determined via fluid draw at the time of insertion) to identify outlier measurements. The values of the metrics varied from measurement to measurement for each insertion. The resulting determination errors were used in conjunction with the values of each of the metrics to determine which metrics offered promise as indicative of the outlier determinations. The trend metrics and value metrics were sorted by their increasing absolute distance to either the calibration or subject mean values.

A number of charts were then created to compare the performance of each metric against the Mahalanobis distance and Q-statistic metrics. In each chart, the individual metrics from each scan were removed to construct a slope of RMSED (the root mean-squared error of determination) versus percent of included data, starting with the most outlying scans. The first few removals removed the worst data, and so observing the metric RMSED as the samples with the largest determination errors were removed showed the effectiveness of the metric.

FIG. 12 is an example of one such chart 300 showing the RMSED for several values and trends for several tailor metric candidates. Note for FIG. 12 the upward direction on the vertical axis corresponds to increasing standard error of determination. Those metrics displaying the steepest slope as higher and higher percentages of data are included (with the worst outliers added last) provide information most closely related to the likelihood of an outlier measurement occurring. Thus, in FIG. 12, the dermal thickness trend 302 is actually a worse predictor (has a greater standard error of determination) than the Q-statistic 304, while the dermal collagen value 306 is better than the Q-statistic 304.

From charts similar to that shown in FIG. 12, several metrics were identified as candidates as model metrics or tailor metrics, or both, while several other metrics were eliminated. Metrics performing better than the Q-statistic were retained. Table 4 shows thirty metrics chosen as good performers. However, several of the metrics can flag the same outliers at once. An additional step in reducing the number of metrics can include a determination of the correlations between the remaining metrics. Two highly correlated metrics will provide similar indications with regards to any given determination, and the pair provides little more information than either by itself.

TABLE 4

| Model Metric Candidates | | Tailor Metric Candidates | |
|---|---|---|---|
| Path metric 1 values | Dermal water STD | Path metric 1 (subject | Path metric 3 (subject |
| | | specific) values | specific) values |
| Path metric 3 STD | Path metric 5 values | Dermal water STD | scatter slope (subject |
| | | | specific) |
| Path metric 4 STD | Peak to trough values | Dermal collagen STD | Path metric 4 (subject |
| | | | specific) values |
| Path metric 4 values | Scatter slope values | Path metric 6 (subject | Path metric 5 (subject |
| | | specific) values | specific) values |

| | | |
|---|---|---|
| Scatter offset STD | Dermal collagen STD | Scatter offset values (subject specific) |
| Dermal thickness | Path metric 5 values | Dermal collagen trend (subject specific) |
| values | | |
| Path metric 3 values | Dermal water values | Dermal collagen values (subject specific) |
| Mean energy values | Scatter slope STD | Dermal water values (subject specific) |
| Out of band energy | | Peak to trough values (subject specific) |
| values | | |

In the illustrative embodiment, a vector for each metric was established using zeroes for acceptable determinations, and ones to indicate outlying determinations. The correlations were calculated using known methods such as that known as “Spearman's Rho” for binary matrices. See, e.g., Sachs, Applied Statistics, A Handbook of Techniques, second edition.

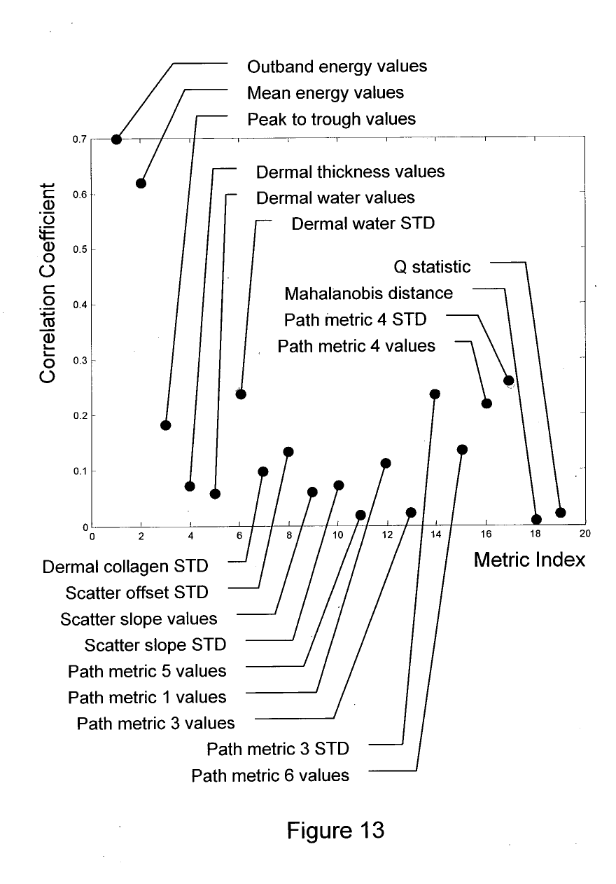

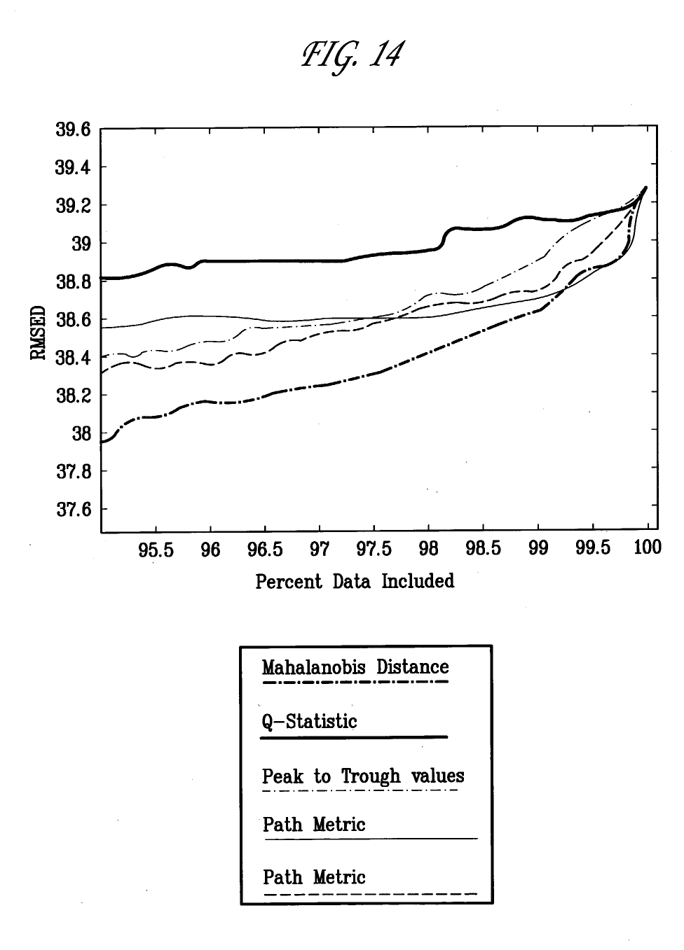

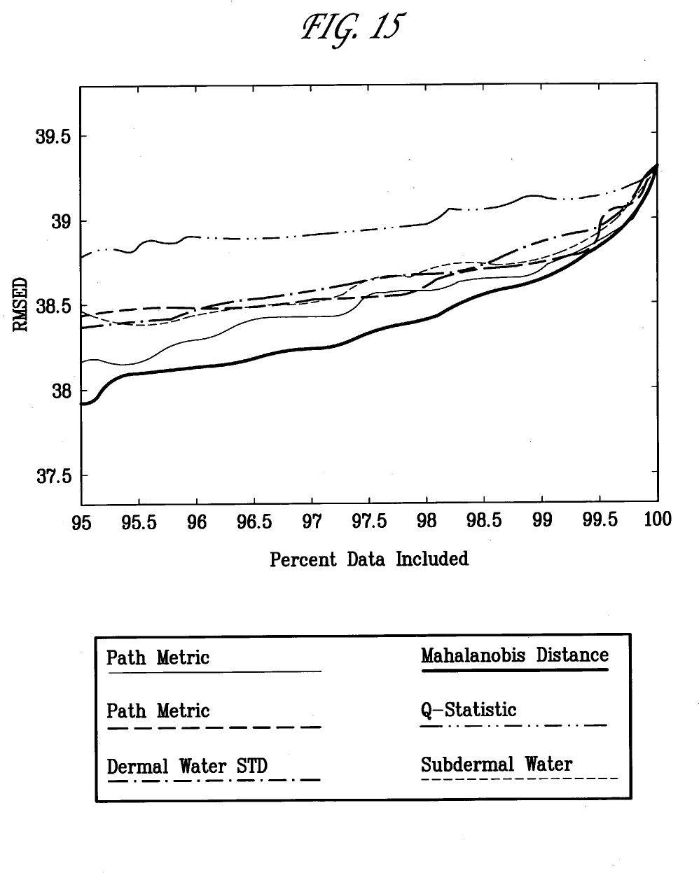

FIG. 13 is a chart of the correlations for several metrics with respect to the model out of band energy values metric. The model mean energy value and the out of band energy value are strongly correlated 310, with a correlation coefficient of about 0.8. Table 5 is a summary of some of the initial correlations.

TABLE 5

| Model Metric Correlations | | |
|---|---|---|
| Mean Energy Values | Out Band Energy Values | 0.8 |
| Peak to Trough Values | Path metric 4 Values | 0.65 |
| Dermal Water STD | Path metric 3 STD | 0.8 |
| Dermal Water STD | Path metric 4 STD | 0.9 |
| Dermal Collagen STD | Scatter Slope STD | 0.65 |
| Scatter Slope Values | Path metric 3 Values | 0.7 |
| Path metric 5 Values | Path metric 6 Values | 0.7 |
| Path metric 3 STD | Path metric 4 STD | 0.7 |
| Tailor Metric Correlations | | |
| Peak to Trough Values (subject | Path metric 4 Values | 0.8 |
| specific) | | |
| Peak to Trough Values (subject | Dermal Water Values (subject specific) | 0.6 |
| specific) | | |
| Dermal Collagen Trend (subject | Dermal Collagen STD | 0.1 |
| specific) | | |
| Scatter Slope Values (subject specific) | Path metric 3 Values (subject specific) | 0.75 |
| Scatter Slope Values (subject specific) | Path metric 6 Values (subject specific) | 0.6 |
| Path metric 5 Values (subject specific) | Path metric 6 Values (subject specific) | 0.6 |
| Path metric 1 Values (subject specific) | Path metric 6 Values (subject specific) | 0.6 |

For the illustrative embodiment, metrics were removed until no pair of remaining metrics had a correlation coefficient of greater than 0.6. Selections between candidate groups (combinations of more than one metric) were made on the basis of the group's capacity to identify outlying scans or insertions. If multiple groups performed similarly in identifying outlying scans/insertions, then only one or two of such groups were retained for actual implementation, and the other groups were regarded as redundant. Eight other metrics were chosen to always be calculated, regardless of the results of this analysis, including scan change value, absorbance variation value, cepstrum values, scaled noise value (noise, optionally scaled to adjust for instrument characteristics), out of band energy value, mean energy standard deviation, specular trend, and peak to trough values; these additional metrics are used in other portions of measurement verification.

Table 6 lists the four model metrics and four tailor metrics remaining after the elimination of poorly performing metrics and highly correlated metrics.

TABLE 6

| Model Metrics | Tailor Metrics |
|---|---|
| Path metric 1 Values | Path metric 1 Values (subject specific) |
| Dermal Water STD | Dermal Water Values (subject specific) |
| Path metric 6 Values | Path metric 3 Values (subject specific) |
| Peak to Trough Values | Dermal Water STD |

Charts of the remaining metrics against Mahalanobis distance and Q-statistic are shown in FIGS. 14 and 15. Note that each of the remaining metrics functions better than the Q-statistic, but Mahalanobis distance still outperforms most metrics most of the time.

The illustrative embodiment shows that a collection of calibration spectra can be used to create a set of representative spectra to develop models for limiting the amount of data needed to calibrate equipment and to validate equipment use in measurement. It is shown that spectra can be monitored in real time using the above selected metrics and provide a useful prediction of measurement validity. Hence, measurement validation can be performed in two ways: first, in real time to assist the user in reducing wasted measurement time by stopping and correcting any errors before an erroneous measurement is complete, and second in post processing to provide a further validation check. In some embodiments, both validation checks are performed, while in other embodiments only one is needed to provide sufficient validation. The desired level of validation can vary depending on the application, e.g. the type of attribute being determined as well as the type of tissue under consideration and the required sensitivity or accuracy of the application.

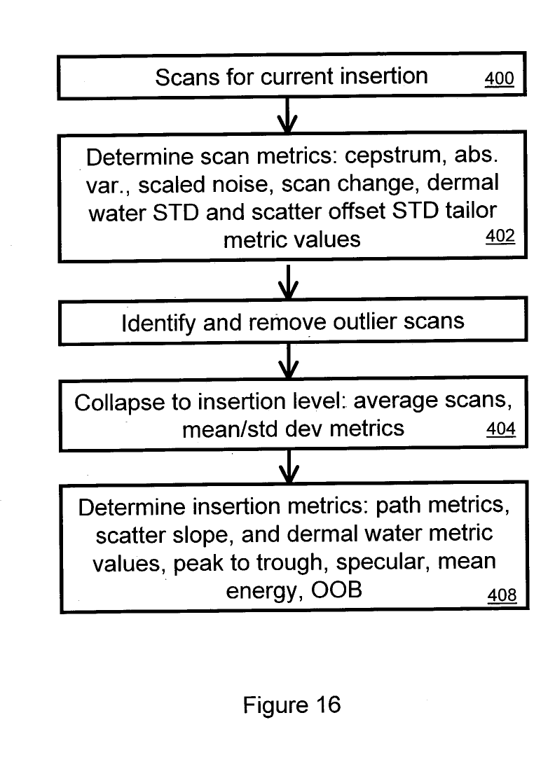

FIG. 16 is a block diagram of calculation and measurement flow for another illustrative embodiment of the present invention acquiring insertion-level spectra. FIG. 16 shows an insertion metric calculation flow scheme for calculating the metric values for use in later measurement analysis. Multiple scans are taken from an insertion 400. The dermal water standard deviation, scatter offset standard deviation, cepstrum, absorption variance, scaled noise, and scan change are calculated 402 from the scan level spectra. Then the several scans taken during an insertion are collapsed to an insertion level spectrum 404 by combining the scan data and the scan-level metrics (e.g., by averaging and/or calculating the standard deviations of acceptable scans, with low quality scans not used in the combination or used with reduced weighting). Additional, insertion-level metrics are calculated 408, based on, for example, either unprocessed or tailored data. See, e.g., “Methods and Apparatus for Tailoring Spectroscopic Calibration Models”, U.S. patent application Ser. No. 09/672,326, incorporated herein by reference, for a discussion of tailoring. For the illustrative embodiment in FIG. 16, after completion of these steps the illustrative embodiment will have multiple metric values for each insertion spectrum. Other embodiments can have different numbers of metrics without limitation.

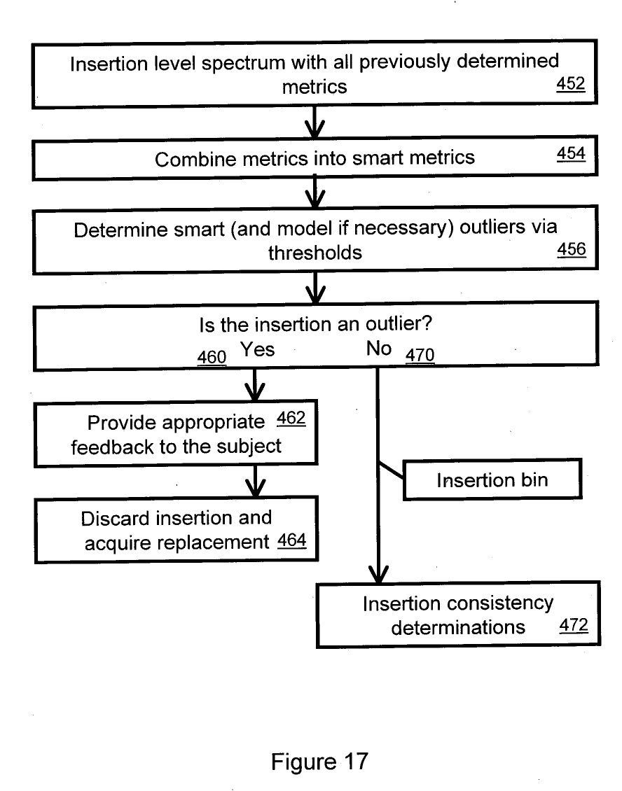

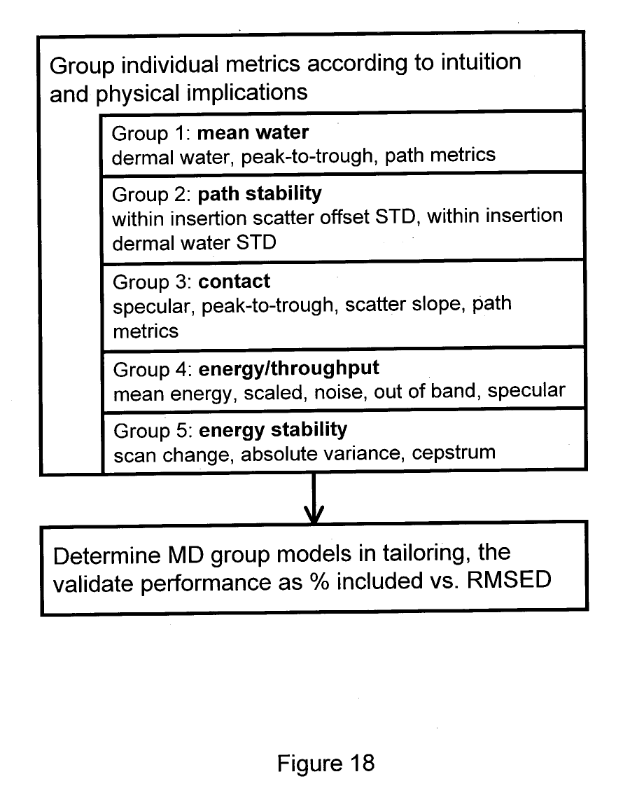

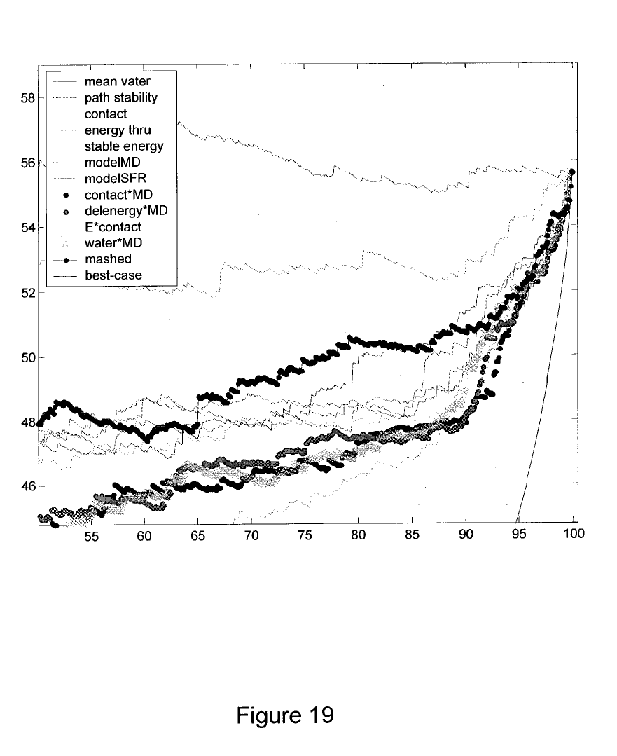

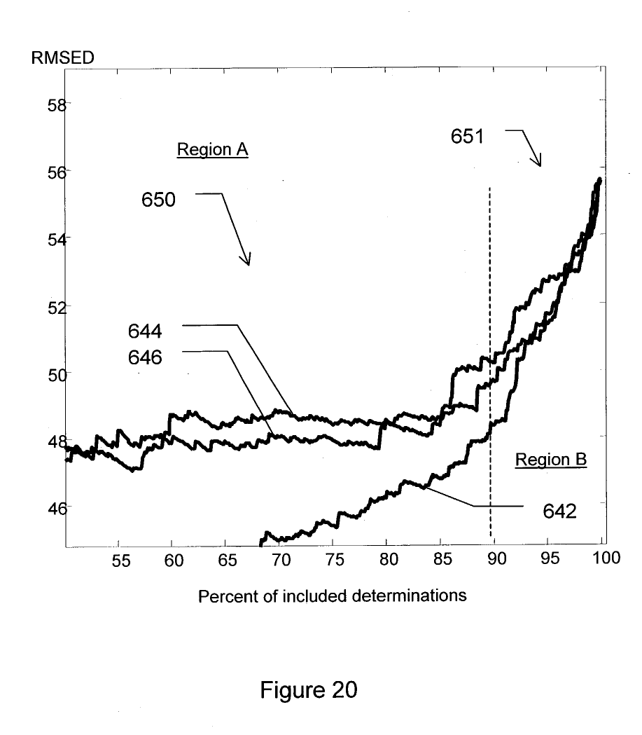

FIG. 17 is a block diagram of an example embodiment of the present invention wherein a collection of “smart” metrics have been defined. The smart metrics could be defined using the methods discussed herein, for example, in the illustrative embodiments of FIGS. 12-15, or also can be derived using the intuitive and physical implication models of the illustrative example shown in FIGS. 20-22, though other methods for deriving combination metrics or sets of representative metrics can be used as well. These combinations and/or sets of individual metrics are chosen for their apparent capacity to predict the validity of a measurement from the values of the spectra.

An insertion level spectrum can be taken 452. The insertion's scans are used to calculate the initial metric values, which are then combined into the smart metrics 454. The smart metrics are then checked to determine whether or not the insertion is predicted to be an outlier 456. Checking the metrics can comprise, for example, comparing the metric to a threshold, where the threshold can be determined from insertions from the same subject, from a representative population, or a combination thereof, depending on the metric and the application. Note that the smart metrics can be taken from an individual scan or from an aggregation of more than one scan. Thus, the detection of a likely outlier insertion before it is completed can be performed using information from a single scan or from multiple scans, as well as from a single metric or a combination of metrics. If the insertion is predicted to be an outlier 460, appropriate user feedback is provided 462, and the insertion is discarded and a replacement acquired 464. If the insertion is not an outlier 470, it is retained. User feedback can also be provided in connection with non-outlier insertions, for example if the metrics indicate a user action that might produce higher quality data. If additional insertions are desired, the process can be repeated. Once sufficient insertions have been acquired, the insertion metrics can be used to identify and remove inconsistent insertions within the group of insertions. The remaining insertions can be used to determine the analyte of interest, or can be further combined and metrics used to determine outlier combinations.

As noted above, metrics can be grouped together and treated as smart metrics in some embodiments of the present invention. For illustrative purposes, consider the following example: supposing a first metric is affected (values increased) by the rate of arterial blood flow through the subject's tissue, a second metric can be affected in an opposing fashion (here, values decreased). The subject's pulse would distort values monitored with both of these metrics, since, using blood glucose as an example analyte for non-invasive testing, the glucose levels in blood are generally not strongly related to the pulse rate of the subject (except in extreme cases where the subject is in medical danger). The metrics can be combined to provide a smart metric, particularly for use in a system where the sampling window is small enough that samples can be taken in a shorter time period than is required for the subject pulse to complete a cycle. The pulse-reliant properties of the first metric can offset the opposing pulse-reliant properties of the second metric. In other words, the noise introduced by variations in blood flow over time can be reduced by combination of metrics. Scans that might have been allowed or disallowed under a single metric can be appropriately treated using a combination of metrics.

FIGS. 20-22 show another illustrative embodiment of the present invention. Metrics are grouped according to intuitive understanding of what each metric represents and the physical implications of the metrics in the example embodiment as shown in Table 7. For example, path stability includes scatter offset standard deviation and dermal water standard deviation metrics. The magnitude of the standard deviations of these metrics is believed to suggest changes during sampling windows of the optical paths of both incident and received radiation. One possible physical implication of path stability would be that a subject, during insertion, is unsteady and has failed to hold tissue securely against the sensor. These groupings illustrate one example of smart metric definitions discussed above.

TABLE 7

| | |
|---|---|
| Group1: tissue hydration | Dermal water, peak-to-trough, Path metric 3, |
| | Path metric 4, Path metric 1 |
| Group2: stability | Within insertion scatter offset STD, within |
| | insertion dermal water STD |
| Group3: contact | Specular, Path metric 5, Path metric 6, |
| | peak-to-trough, scatter slope |
| Group4: energy/throughput | Mean energy, scaled noise, |
| | out-of-band, specular |
| Group5: energy stability | Scan change, abs. variance, cepstrum |

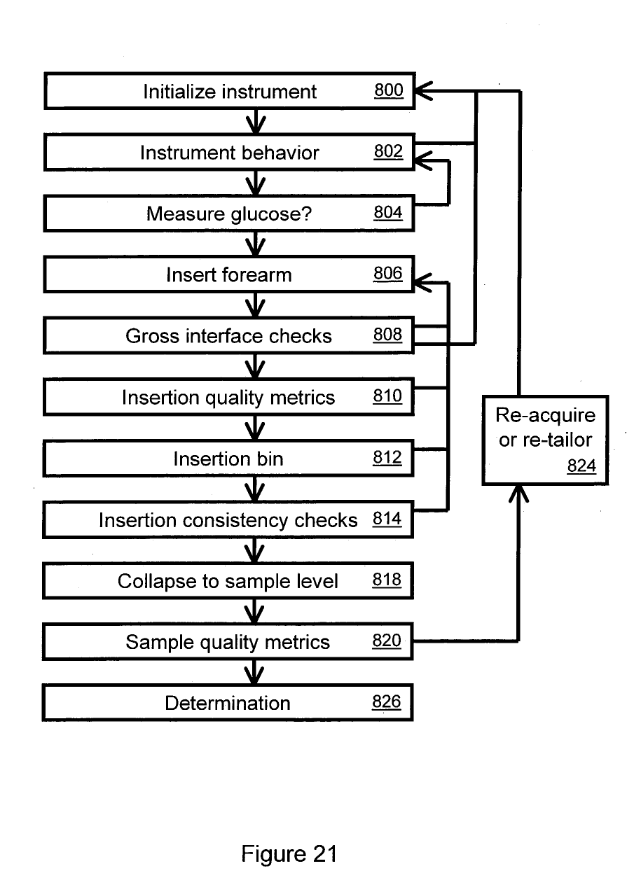

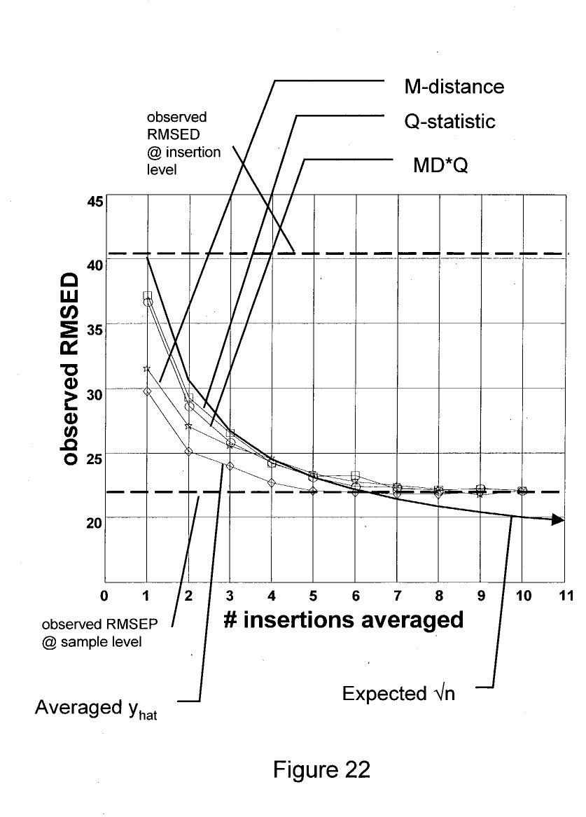

FIGS. 20-21 are graphs comparing several grouped metrics in Table 7 to the Mahalanobis distance for the same subject. Mahalanobis distance 642, contact group 644, and energy stability group 646 are shown. While the Mahalanobis distance 642 outperforms other metrics with lower percentages of determinations included as shown in Region A 650, the other metric groups 644, 646 perform quite favorably when more than ninety percent of determinations are included in the graph as in Region B 652. Because the determinations are added in order of their accuracy, with the worst performing determinations added last, it is apparent from the chart in FIG. 22 that, for this particular subject, the contact group 644 and the energy stability group 646 function well as surrogates for Mahalanobis distance 642 for the worst insertions, and have the added advantage of being ‘directive’ in that the user can understand the implications of these metrics.

For the illustrative example in FIGS. 20-22, these group metrics can be monitored at a level lower than that of the entire measurement. For example, on a scan-by-scan basis the groups can be monitored in real time prior to completion of the data acquisition for a determination. Some groups can be identified as performing well for particular subjects, especially for the worst outlier determinations, and so these groups can enable real time feedback to take place during a measurement. Because the Mahalanobis distance calculation lumps together many factors, it does not necessarily provide an adequate basis for informative feedback to the user; and these intuitively grouped metrics can be useful for feedback sampling.

FIG. 21 is a high level flow chart for obtaining a glucose measurement. For the illustrative embodiment, an insertion can be defined as a number of scans corresponding to a fifteen second time interval. The actual number of scans required to be taken for an insertion can be larger than the number obtained in a given fifteen second time interval, because, as will be seen, poor quality scans can sometimes be excluded without discarding the entire insertion. A number of insertions are used to create a single determination in this illustrative embodiment. For this illustrative example, a forearm insertion sleeve is used, for example, as shown in FIG. 5.

The reasoning behind using a number of insertions can be illustrated with reference to FIG. 24, which is derived from gathered data using fifteen second insertion intervals. FIG. 24 shows comparison of a number of possible determination validation metrics. On the left side of the chart, the root mean standard error of determination value is shown for a single insertion, and as more insertions are added, the RMSED changes for the averaged insertions. Notably, the RMSED drops significantly for the first few added insertions.

In FIG. 23, the re-initialize instrument block 800 ensures that the instrument is scanning and acquiring data with no obvious electrical or mechanical problems. In most situations, a number of insertions sufficient to complete a determination can be taken before re-initialization 800 is required. Thus, the re-initialization 800 is deemed to be outside the measurement loop, and is typically only called for in the illustrative embodiment when some other part fails sufficiently to require re-starting the measurement.

The instrument behavior step 802 verifies that the instrument is operating within parameters established during calibration. This step 802 can include scan metrics performed on a known sample, and can include a control model or control sample testing step. If the instrument passes both the instrument behavior check 802 and the re-initialize instrument block 800, then it is prepared for subject data acquisition. The scan metrics for the instrument behavior step 802 are included to verify that scan spectra do not contain instrument-related artifacts or instability. Any existing scan level metric or metrics specific to instrument state can be chosen, for example, scan metrics including the cepstrum, absorbance variance, scan change and scaled noise could be used. The control model or control sample can be used to verify that the instrument's state is within the range of states encountered during the subjects tailoring period and the calibration period. If the instrument is not within the predefined tolerances, a correction can be determined and applied to subsequent spectral data. Also, if the instrument fails to meet the tailor tolerances, the device can provide a suggestion that a new tailoring be performed.

The measure glucose block 804 is a subject-triggered event 805. It can include some form of user input such as a button. The measure glucose block 804 causes the instrument to leave the instrument behavior block 802 and begin the series of subject data acquisition steps.

The insert forearm block 806 prompts the subject to initiate an interface with the instrument, for example by inserting his or her forearm into a cradle or cuff. Depending on the protocol and the implementations, this step could be combined with the measure glucose block 804. For example, the cradle can include a sensor for sensing when a forearm is inserted, and prompt the start of data acquisition.

The gross interface checks block 808 accomplishes three purposes: an instrument check, spectral shape verification, and contact verification. The instrument check includes checking whether the instrument was perturbed in an unrecoverable manner when the forearm was inserted 806, for example, if it was bumped or jolted out of alignment. These checks can include cepstrum, scaled noise, and absorbance variance. Some further embodiments include a scan change function where individual scan values for these three metrics are retained to allow bad scans to be flagged and removed from the overall measurement, and replacement scans captured instead. For embodiments allowing scan change, the fifteen second insertion interval could be taken over a time period exceeding fifteen seconds, so long as a sufficient number of scans is captured. Additional aspects of a scan change function can include a capacity to count bad scans and possibly reject an insertion or a capacity to dump poor scans within a fifteen second time interval and interpolate data from adjacent scans prior to and after the dumped poor scan, for example.

Spectral shape verification provides assurance that the inserted sample is a human forearm. Several metrics can be used in this portion; in one illustrative embodiment the peak to trough and mean energy value metrics are used, but others can be used as well. The contact verification checks for interface quality metrics such as cleanliness. The contact verification checks can include specular and mean energy value metrics, as well as other metrics for detecting foreign substances or hair in the interface as well as gaps. In another illustrative embodiment, contact verification includes checking whether an interface index matching medium has been properly applied by detecting a peak in absorbance at a wavelength known to be strongly absorbed by the medium. These gross interface checks 808 occur in a short period of time for each insertion, and in other embodiments can be repeated during a single insertion. If the instrument check fails, the instrument goes to re-initialization 800. If the spectral shape or contact verifications fail, the subject is asked to reinsert the forearm 806.

Following gross interface checks 818, the insertion quality metrics 810 determine whether the insertion is within the subject's tailored space and determine whether the insertion is within the calibration model space. If an insertion ‘passes’ both of these tests, the insertion is kept in the insertion bin 812 and additional insertions are acquired until a preselected number of insertions are accrued. Then, for the illustrative example, the kept insertions are checked for their consistency 814. If an insertion fails, the subject is directed to reinsert the forearm. If two insertions fail, the subject can be directed to re-tailor.

For calibration relative (i.e., compared to a representative population) insertion quality determination in 810, the illustrative example includes seventeen metrics (defined in Table 3). The metrics are listed in Table 8.

TABLE 8

| | |
|---|---|
| Mahalanobis Distance | Path metric 1 values |
| Scatter Slope values | Dermal Water values |
| Peak to Trough values | Path metric 3 values |
| Dermal Water Standard Deviation | Path metric 5 values |
| Q statistic | Scan Change value (Standard Metric) |
| Absorbance Variation value (Standard Metric) | Cepstrum values (Standard Metric) |
| Scaled Noise value (Standard Metric) | Out of band energy value (Standard Metric) |
| Mean Energy Standard Deviation (Standard | Specular trend (Standard Metric) |
| Metric) | |
| Peak to Trough values (Standard Metric) | |

For the starred metrics in Table 8, the input is an absorbance spectrum covering a wavelength range 1.25 μm to 2.5 μm. With the exception of dermal water standard deviation, which is calculated at the scan level, the starred metrics are calculated at the insertion level. The methodology for calculating the metric values in Table 8 is discussed in Table 3 and paragraphs 0056-0060. In an example embodiment, for each metric, the mean metric value is calculated and removed for each subject present in the calibration. The centered metric values from all subjects are combined in order to determine outlier/inlier thresholds for future metric values (from validation insertions), where an “inlier” is a spectrum that lies within the outer boundaries of the metric values associated with the calibration spectra but is not proximate to any individual metric value from the calibration.

For the illustrative embodiment, the above metrics are also combined together into smart metrics as described in FIG. 17 and paragraph 0071. For each smart metric, the appropriate individual calibration metric values are scaled so that each metric contributes representatively to the combination, yielding is a matrix of m (the number of calibration spectra) by n scaled metrics. The metric values of validation insertions are similarly scaled and formed into a 1 by n vectors. The Mahalanobis distance of the validation insertions' smart metrics (vectors 1 by n) are calculated relative to the m by n matrix of scaled calibration metric values. This Mahalanobis distance is not to be confused with a spectral Mahalanobis distance, which is a metric listed in Table 8 and can be an input to one or more Smart metrics. The threshold of the metric Mahalanobis distance can be determined by calculating the metric distance associated with each calibration spectrum relative to the rest of the calibration. The resulting group of metric distances is then used to define the threshold for future validation insertions. If a validation insertion is flagged as an outlier by one or more calibration relative metrics it is deemed outside the calibration model space and will not be used in subsequent analysis. If appropriate, the user will be directed to acquire an additional insertion. Depending on the combination of metric responses for the validation insertion and the necessity of additional insertions, one or more corrective actions may be indicated and conveyed to the user.

For tailor relative (i.e., compared to past spectra of the same subject) insertion quality determination in 810, the illustrative example includes sixteen metrics (defined in Table 3). The metrics are listed in Table 8.

TABLE 9

| | |
|---|---|
| Mahalanobis Distance | Path metric 1 values |
| Within Insertion Dermal Water Standard | Path metric 6 Values |
| Deviation | |
| Peak to Trough Values (Standard Metric) | Path metric 4 values |
| Scatter Slope values | Within Insertion Scatter offset Standard Deviation |
| Out of Band Energy Values (Standard Metric) | Q statistic |
| Scan change value (Standard Metric) | Absorbance variation value (Standard Metric) |
| Cepstrum values (Standard Metric) | Scaled noise value (Standard Metric) |
| Mean energy standard deviation (Standard Metric) | Specular trend (Standard Metric) |

For the seven starred metrics, the metric values are calculated as above with the calibration relative metrics. The outlier/inlier thresholds are calculated using the metric values from the subject's tailoring period. The tailor metrics are also combined into smart metrics (although not necessarily the same combinations as the calibration smart metrics) in this illustrative embodiment. The thresholds of tailor relative smart metrics are determined from the distance values associated with the tailor spectra. If a validation insertion is flagged as an outlier by one or more tailor relative metrics it is deemed outside the subject's tailor space and will not be used in subsequent analysis. If appropriate, the user will be directed to acquire an additional insertion. Depending on the combination of metric responses for the validation insertion and the necessity of additional insertions, one or more corrective actions may be indicated and conveyed to the user. If a validation insertion is not flagged as an outlier by either the calibration model or tailor relative metrics it is passed to insertion bin 812 for subsequent analysis and processing.

An insertion bin 812 is also included. The purpose of the insertion bin 812 is to store insertion spectra and their metric values until a specified number of acceptable insertions have been accumulated. As noted above, for this illustrative example using fifteen second insertions, the specified number could be around seven insertions, since FIG. 22 shows that the rate of decrease in the root mean squared error of determination tends to become insignificant after about seven of the fifteen second insertions are averaged. Additionally, for a case where one or more good insertions are captured before a bad insertion is detected, the insertion bin 812 allows the good data to be preserved. There can be limits on such preservation; for example, binned data can be dumped if a re-initialization 800 is performed.

Before the several insertions are collapsed into a sample 818, an insertion consistency check 814 is performed to determine if the accumulated insertions are equivalent to each other. The check is performed using measurement error distributions from each insertion as well as measurement probabilities and, in some illustrative embodiments, spectral variance based metrics. Any insertions that are deemed not equivalent can be discarded, and additional insertions gathered to replace them if necessary.

Prior to determination 826 in the illustrative embodiment of FIG. 22, sample quality metrics 820 can also be checked. At this level, Mahalanobis distance and Q-statistic (of spectra or of metrics), relative to the subjects tailor space or to the calibration space, can be sufficient for verification. If the prior steps are performed properly, there will likely be very few sample outliers relative either to model or tailor spaces. Finally, when the determination is made, there will be strong confidence that the glucose determination will be within the accuracy requirements of the system.

To summarize the illustrative example of FIG. 22, there are five blocks that correspond to measurement quality checks within the system. The instrument behavior block 802 checks whether the instrument itself is working. The gross interface checks block 808 determines whether the interface between tissue and instrument meets certain base guidelines for quality, and provides an early-system check that can be performed well before an insertion spectrum is completely gathered. The insertion quality metrics block 810 includes a higher level of guidelines than the gross interface checks 808, and performs analysis on each insertion to determine whether the insertion itself provides data that can support a reliable determination of blood glucose. The insertion consistency checks block 814 determines whether the obtained insertion data correlates sufficiently well with other insertions in the same measurement. The sample quality metrics block 820 then performs a final overall check of the data to determine whether it meets all measurement criteria required before a determination is made.

Those skilled in the art will recognize that the present invention can be manifested in a variety of forms other than the specific embodiments described and contemplated herein. Accordingly, departures in form and detail can be made without departing from the scope and spirit of the present invention as described in the appended claims.

We claim:

1. A method of acquiring a plurality of scans from a subject for use in a determination of a biological attribute, comprising:
a. Acquiring a spectrum, comprising a subset of the plurality of scans, from the subject;
b. Determining whether the spectrum is suitable for use in the determination, and, if so, indicating that the spectrum is suitable for use in the determination; and
c. Repeating steps a and b until the plurality of scans has been acquired.

2. A method as in claim 1, wherein the plurality of scans does not include any spectra not identified as suitable for use in the determination.

3. A method as in claim 1, wherein determining whether the spectrum is suitable comprises analyzing the spectrum for suitability.

4. A method as in claim 3, wherein determining whether the spectrum is suitable further comprises analyzing an auxiliary sensor.

5. A method as in claim 3, wherein analyzing the spectrum for suitability comprises analyzing the spectrum for the magnitude, variability, direction of variability, measure of dispersion, trend, or combination thereof, of a metric determined from the spectrum.

6. A method as in claim 5, wherein the metric comprises a mean water metric.

7. A method as in claim 6, wherein the mean water metric is derived from one or more of the dermal water value, peak to trough value, and path metrics.

8. A method as in claim 5, wherein the metric comprises a path stability metric.

9. A method as in claim 8, wherein the path stability metric is derived from one or more of the scatter offset standard deviation, and the dermal water standard deviation.

10. A method as in claim 5, wherein the metric comprises a contact metric.

11. A method as in claim 10, wherein the contact metric is derived from one or more of the specular value, path metrics, peak to trough value, and scatter slope.

12. A method as in claim 5, wherein the metric comprises an energy captured metric.

13. A method as in claim 12, wherein the energy captured metric is derived from one or more of the mean energy value, the scaled noise value, the out of band energy value, and the specular value.

14. A method as in claim 5, wherein the metric comprises an energy stability metric.

15. A method as in claim 14, wherein the energy stability metric is derived from one or more of the scan change value, the absorbance variance, and the cepstrum values.

16. A method as in claim 5, wherein the measure of dispersion comprises standard deviation, mean absolute deviation, median absolute deviation, or interquartile range.

17. A method of acquiring a spectrum from a subject for use in determination of a biological attribute, comprising:
a. Acquiring a spectrum from the subject;
b. Determining whether a subject-affected characteristic of the spectrum acquisition is likely to affect the accuracy of the determination, and, if so, communicating information to the subject that allows the subject to affect the characteristic.

18. A method as in claim 17, further comprising repeating steps a and b until step b indicates that the characteristic is unlikely to cause an error in the determination.

19. A method as in claim 17, wherein determining whether a subject-affected characteristic of the spectrum acquisition is likely to affect the accuracy of the determination comprises analyzing the spectrum for the magnitude, variability, direction of variability, measure of dispersion, trend, or combination thereof, of a metric determined from the spectrum

20. A method as in claim 19, wherein the spectrum comprises a plurality of scans, and wherein analyzing the spectrum comprises comparing a first scan within the spectrum with a second scan within the spectrum.

21. A method as in claim 19, wherein analyzing the spectrum comprises determining a metric from the data in the spectrum, and comparing the metric with a predetermined value.

22. A method as in claim 21, wherein the metric comprises a mean water metric.

23. A method as in claim 22, wherein the mean water metric is derived from one or more of the dermal water value, peak to trough value, and path metrics.

24. A method as in claim 21, wherein the metric comprises a path stability metric.

25. A method as in claim 24, wherein the path stability metric is derived from one or more of the scatter offset standard deviation, and the dermal water standard deviation.

26. A method as in claim 21, wherein the metric comprises a contact metric.

27. A method as in claim 26, wherein the contact metric is derived from one or more of the specular value, path metrics, peak to trough value, and scatter slope.

28. A method as in claim 21, wherein the metric comprises an energy captured metric.

29. A method as in claim 28, wherein the energy captured metric is derived from one or more of the mean energy value, the scaled noise value, the out of band energy value, and the specular value.

30. A method as in claim 21, wherein the metric comprises an energy stability metric.

31. A method as in claim 30, wherein the energy stability metric is derived from one or more of the scan change value, the absorbance variance, and the cepstrum values.

32. A method as in claim 19, wherein the spectrum comprises a plurality of scans, and wherein analyzing the spectrum comprises determining a measure of dispersion of the plurality of scans.

33. A method as in claim 32, wherein the measure of dispersion comprises standard deviation, mean absolute deviation, median absolute deviation, or interquartile range.

34. A method as in claim 19, wherein the spectrum comprises a plurality of scans, and wherein analyzing the spectrum comprises determining a trend of a metric determined from the data in the plurality of scans.

35. A method of determining a biological attribute of tissue of a subject, comprising:
a. Acquiring a spectrum of the tissue;
b. Determining a plurality of metrics from the spectrum;
c. Determining whether any of the determined metrics indicate a likelihood of error in an attribute determination using the spectrum, and, if so, identifying the spectrum as not-to-be-used, if not, identifying the spectrum as to-be-used;
d. Determining whether any of the determined metrics indicate that a subject action is likely to affect the value of a metric and, if so, communicating information to the subject that allows the subject to perform such action;
e. Repeating steps a, b, c, and d until a terminal condition is reached;
f. Determining the biological attribute using a multivariate model applied to the spectra identified as to-be-used.

36. A method as in claim 35, wherein the terminal condition comprises acquisition of a desired number of spectra identified as to-be-used.

37. A method as in claim 35, wherein the terminal condition comprises lapse of a selected time.

38. A method as in claim 35, wherein the terminal condition depends on at least one of the determined metrics.

39. A method as in claim 35, wherein the spectrum comprises a plurality of scans, and wherein analyzing the spectrum comprises comparing a first scan within the spectrum with a second scan within the spectrum.

40. A method as in claim 35, wherein at least one of the plurality of metrics comprises a mean water metric.

41. A method as in claim 40, wherein the mean water metric is derived from one or more of the dermal water value, peak to trough value, and path metrics.

42. A method as in claim 35, wherein at least one of the plurality of metrics comprises a path stability metric.

43. A method as in claim 42, wherein the path stability metric is derived from one or more of the scatter offset standard deviation, and the dermal water standard deviation.

44. A method as in claim 35, wherein at least one of the plurality of metrics comprises a contact metric.

45. A method as in claim 44, wherein the contact metric is derived from one or more of the specular value, path metrics, peak to trough value, and scatter slope.

46. A method as in claim 35, wherein at least one of the plurality of metrics comprises an energy captured metric.

47. A method as in claim 46, wherein the energy captured metric is derived from one or more of the mean energy value, the scaled noise value, the out of band energy value, and the specular value.

48. A method as in claim 35, wherein at least one of the plurality of metrics comprises an energy stability metric.

49. A method as in claim 47, wherein the energy stability metric is derived from one or more of the scan change value, the absorbance variance, and the cepstrum values.

50. A method as in claim 35, wherein the spectrum comprises a plurality of scans, and wherein analyzing the spectrum comprises determining a measure of dispersion of the plurality of scans.

51. A method as in claim 50, wherein the measure of dispersion comprises standard deviation, mean absolute deviation, median absolute deviation, or interquartile range.

52. A method as in claim 35, wherein the spectrum comprises a plurality of scans, and wherein analyzing the spectrum comprises determining a trend of a metric determined from the data in the plurality of scans.

53. A method as in claim 35, wherein the metrics comprise a metric correlated with the contribution of another substance to the spectrum, and wherein communicating information comprises communicating information regarding the presence of the other substance if the metric so indicates.

54. A method as in claim 35, wherein communicating information comprises providing a text display accessible by the subject.

55. A method as in claim 35, wherein communicating information comprises providing a graphic display accessible by the subject.

56. A method as in claim 35, wherein the metrics comprise a metric correlated with the stability of an interface between the tissue and a spectrum acquisition instrument.

57. A method as in claim 35, wherein communicating information comprises providing a sound audible to the subject.

58. A method as in claim 35, wherein communicating information comprises providing words audible to the subject.

59. A method as in claim 35, wherein the metrics comprise a metric correlated with one or more of: placement of a spectrum acquisition sensor with respect to the tissue, cleanliness of an interface between the tissue and a spectrum acquisition instrument, steadiness of the placement of a spectrum acquisition sensor with respect to the tissue, the type of tissue analyzed, characteristics of a medium disposed between a spectrum acquisition sensor and the tissue, temperature, existence of extraneous substances in or near the interface between the tissue and a spectrum acquisition instrument, the angle at which the interface between the tissue and a spectrum acquisition instrument occurs with respect to the tissue, and variations in the distance between a spectrum acquisition sensor and the tissue.

60. A method of determining user-interactive metrics relating to spectra used in determining biological attributes in a system interacting with a user, comprising:
a. Determining a plurality of initial metrics determinable from information in a spectrum;
b. Selecting a plurality of preferred metrics as those initial metrics whose values are related to improved performance of the determination method;
c. Associating a user interaction with at least some of the preferred metrics, where the user interaction comprises information related to actions of a user that are related to the associated metric.

61. A method as in claim 60, wherein selecting a plurality of preferred metrics comprises identifying and combining preferred metrics whose combination is related to improved performance of the determination method.

62. A method as in claim 60, wherein the user interaction comprises information to be communicated to the user that allows the user to affect the metric.

63. An apparatus for determining a biological attribute of tissue, comprising:
a. A spectrum acquisition system;
b. A metric determination system, responsive to spectra acquired by the spectrum acquisition system;
c. A user interaction system, responsive to the metric determination system;
d. An attribute determination system, comprising a multivariate model and responsive to the spectrum acquisition system.

64. An apparatus as in claim 63, wherein the metric determination system comprises means for analyzing the spectrum for the magnitude, variability, direction of variability, measure of dispersion, trend, or combination thereof, of a metric determined from the spectrum.

65. An apparatus as in claim 63, wherein the metric determination system comprises means for analyzing the spectrum to determine a mean water metric.

66. An apparatus as in claim 63, wherein the metric determination system comprises means for analyzing the spectrum to determine a path stability metric.

67. An apparatus as in claim 63, wherein the metric determination system comprises means for analyzing the spectrum to determine a contact metric.

68. An apparatus as in claim 63, wherein the metric determination system comprises means for analyzing the spectrum to determine an energy captured metric.

69. An apparatus as in claim 63, wherein the metric determination system comprises means for analyzing the spectrum to determine an energy stability metric.

70. An apparatus as in claim 63, wherein the spectrum acquisition system comprises a cradle adapted to receive a human forearm, the cradle having an optical interface adapted to acquire a spectrum from forearm tissue placed in proximity thereto.

71. An apparatus as in claim 63, wherein the user interaction system comprises an audio output device and a plurality of audio signals associated with information from the metric determination system.

72. An apparatus as in claim 63, wherein the user interaction system comprises a display whose visible appearance is changeable responsive to information from the metric determination system.

73. An apparatus as in claim 72, wherein the display comprises a status light, a text display, a bar graph display, a dial display, or a combination thereof.
